(19) United States
(12) Patent Application Publication
(10) Pub. No.: US 2008/0007860 A1
(43) Pub. Date: Jan. 10, 2008

(54) Disk array control apparatus and method

(75) Inventors: Michitaro Miyata, Tokyo (JP); Yoshihiro Hasebe, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/822,201

(22) Filed: Jul. 3, 2007

(30) Foreign Application Priority Data
Jul. 4, 2006 (JP) 2006-184368

(51) Int. Cl. G11B 19/02

(52) U.S. Cl. 360/69

(57) ABSTRACT

A disk array control apparatus is capable of individually controlling disk states of a plurality of hard disk drives disposed in a disk array. A rotation control time determination unit calculates a control time for controlling the disk state of each of the plurality of hard disk drives based on previously set time information related to a start and a stop of use, and adjusts the calculated control times based on a mutual relationship of the control times to one another. A hard disk drive control unit controls the disk state of each hard disk drive at the control time determined by the rotation control time determination unit.

This application is based upon and claims the benefit of priority from Japanese Patent Application No. 2006-184368 filed on Jul. 4, 2006, the content of which is incorporated by reference.

### BACKGROUND OF THE INVENTION

1. Field of the Invention

The present invention relates to a disk array control apparatus for controlling a disk array device which comprises a plurality of hard disk drives.

2. Description of the Related Art

A variety of controls have been conducted for reducing power consumption of disk array devices. For example, a known technique will turn off a hard disk drive (hereinafter called “HDD”) when it has not been accessed for a certain time period, or will stop the rotation of a disk in the HDD when the HDD has not been accessed for a certain time period, thereby reducing power consumption of the disk array device. In this event, in response to an access command the HDD is powered on or the disk starts to rotate so that the HDD can be accessed.

For example, in a disk array device described in JP-A-2000-293314 (hereinafter called “Document 1”), when HDDs have not been accessed from a higher layer device for a predetermined time period, the group of HDDs is set into a power save mode. Such a technique is known as MAID (Massive Array of Idle Disk) in recent years (see Dennis Colarelli, Dirk Grunwald and Michael Neufelt, “The Case for Massive Arrays of Idle Disks (MAID)”, Jan. 7, 2002, which is hereinafter called “Document 2”).

This MAID draws attention mainly as a technique for applications such as large scale disk backup and disk archiving. Nevertheless, powering off HDDs for a period in which no access is made thereto, and stopping the rotation of disks are widely effective methods for reducing the power consumption of a system in which HDDs are not accessed for a relatively long time period, as well as reducing power consumption for disk backup and disk archiving.

JP-A-2002-251816 (hereinafter called “Document 3”) in turn discloses a disk recording/reproducing apparatus for recording and reproducing a video signal and an audio signal on and from an HDD. Though Document 3 does not relate to a disk array device, Document 3 discloses, in Paragraph 0037, the following technique. When a time is reserved for recording or reproducing, the HDD is activated and maintained in a warm up state based on the time which is set for activating the HDD to perform recording and or reproduction.

However, the foregoing techniques have the following problems.

A disk array device may include a mixture of HDDs, some of which are accessed all day long and some of which are not accessed at night. In this event, the use of MAID as shown in Document 2 or Document 1 can stop the group of HDDs which are not accessed at night to reduce the power consumption.

However, it generally takes several tens of seconds to rotate a disk, when it is stopped, so that it can be accessed. For this reason, the response of a disk which is in a stopped condition, in a HDD to an access command is very slow compared to the response of a HDD in a normal operation condition to an access command.

Also, a larger current is needed for an operation that involves rotating a disk that is in a stopped condition (activating operation) and for an operation that involves stopping the rotation of a disk (stopping operation) than the current used in normal operations.

If access is simultaneously made to a plurality of HDDs having disks that are in a stopped condition, operations take place to simultaneously activate the plurality of HDDs. Also, if the HDDs that have been simultaneously accessed are not subsequently accessed HDDs are not subsequently accessed for a certain period of time, operations take place to simultaneously stop a plurality of these HDDs. When activating or stopping operations concentrated in a short time period, power consumption can temporarily increase to a very high level. In addition, depending on the degree of the concentration, the concentrated operations can cause a consumed current to exceed the allowance of the device.

On the other hand, according to Document 3, it is possible to reserve to make disks in HDDs which are not accessed at night rotate only in the daytime. The disks have been previously rotated before access are actually made, thus making it possible to ensure a fast response to accesses. However, even when such a strategy is used, if a time is reserved for the activating or stopping operations to occur at the same time, these operations will take place simultaneously. In other words, the technique disclosed in Document 3 fails to solve the problem of an increase in power consumption due to the activating operations or stopping operations which take place simultaneously.

### SUMMARY OF THE INVENTION

It is an object of the present invention to provide a disk array control apparatus which is capable of accomplishing both a reduction in power consumption and a fast response when accessed, and restraining an increase in current that will be consumed in an activating operation or a stopping operation.

To achieve the above object, the present invention provides a disk array control apparatus for individually controlling disk states of a plurality of hard disk drives disposed in a disk array. The disk array control apparatus includes a rotation control time determination unit for calculating a control time for controlling the disk state of each of the plurality of hard disk drives based on previously set time information related to a start and a stop of use, and adjusting the calculated control times based on a mutual relationship of the control times to one another, and a hard disk drive control unit for controlling the disk state of each hard disk drive at the control time determined by the rotation control time determination unit.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram illustrating a system according to a first exemplary embodiment;

FIG. 2 is a table showing information recorded in use time memory unit 21 in the first exemplary embodiment;

FIG. 3 is a table showing information recorded in rotation control time memory unit 22 in the first exemplary embodiment;

FIG. 4 is a flow chart illustrating a rotation control time determination process in the first exemplary embodiment;

FIG. 5 is a flow chart illustrating an HDD control process in the first exemplary embodiment;

FIG. 6A is a flow chart illustrating details of a rotation control time setting process shown at step A4 in FIG. 4;

FIG. 6B is a flow chart illustrating details of the rotation control time setting process shown at step A4 in FIG. 4;

FIG. 6C is a flow chart illustrating details of the rotation control time setting process shown at step A4 in FIG. 4;

FIG. 6D is a flow chart illustrating details of the rotation control time setting process shown at step A4 in FIG. 4;

FIG. 7 is a table showing an example of use times set in use time memory unit 21 in the first exemplary embodiment;

FIG. 8A is a table showing a first example of rotation control times set in rotation control time memory unit 22 in the first exemplary embodiment;

FIG. 8B is a table showing a second example of rotation control times set in rotation control time memory unit 22 in the first exemplary embodiment;

FIG. 8C is a table showing a third example of rotation control times set in rotation control time memory unit 22 in the first embodiment;

FIG. 8D is a table showing a fourth example of rotation control times set in rotation control time memory unit 22 in the first embodiment;

FIG. 8E is a table showing a fifth example of rotation control times set in rotation control time memory unit 22 in the first embodiment;

FIG. 8F is a table showing a sixth example of rotation control times set in rotation control time memory unit 22 in the first exemplary embodiment;

FIG. 9 is a block diagram illustrating a system according to a second exemplary embodiment;

FIG. 10 is a table showing information recorded in use time memory unit 21 in the second exemplary embodiment;

FIG. 11 is a table showing information recorded in rotation control time memory unit 22;

FIG. 12 is a flow chart illustrating a rotation control time determination process in the second exemplary embodiment;

FIG. 13 is a flow chart illustrating an HDD control process in the second exemplary embodiment;

FIG. 14A is a flow chart illustrating details of a rotation control time setting process shown at step A11 in FIG. 12;

FIG. 14B is a flow chart illustrating details of the rotation control time setting process shown at step A11 in FIG. 12;

FIG. 14C is a flow chart illustrating details of the rotation control time setting process shown at step A11 in FIG. 12;

FIG. 14D is a flow chart illustrating details of the rotation control time setting process shown at step A11 in FIG. 12;

FIG. 15 is a table showing an example of logical unit information recorded in logical unit information memory unit 23;

FIG. 16 is a table showing an example of use times set in use time memory unit 21 in the second exemplary embodiment;

FIG. 17A is a table showing a first example of information set in rotation control time memory unit 22 in the second exemplary embodiment;

FIG. 17B is a table showing a second example of rotation control times set in rotation control time memory unit 22 in the second exemplary embodiment;

FIG. 17C is a table showing a third example of rotation control times set in rotation control time memory unit 22 in the second exemplary embodiment;

FIG. 18 is a block diagram illustrating a system according to a third exemplary embodiment;

FIG. 19 is a table showing information stored in margin time memory unit 24 in the third exemplary embodiment;

FIG. 20 is a flow chart illustrating an HDD control process in the third exemplary embodiment; and

FIG. 21 is a table showing a specific example of information stored in margin time memory unit 24 in the third exemplary embodiment.

### DETAILED DESCRIPTION OF THE PREFERRED EMBODIMENTS

Embodiments of the present invention will be described in detail with reference to the drawings.

### First Embodiment

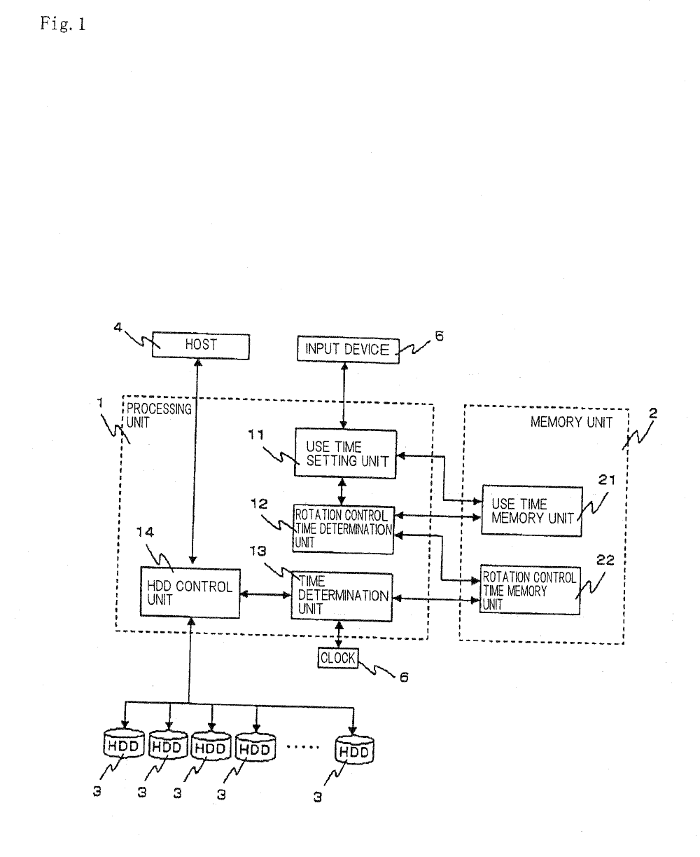

FIG. 1 is a block diagram illustrating a system according to a first exemplary embodiment. Referring to FIG. 1, the system according to the first exemplary embodiment comprises processor 1, storage unit 2, a plurality of HDDs 3, host 4, input device 5, and clock 6.

Processor 1 comprises use time setting unit 11, rotation control time determination unit 12, time determination unit 13, and HDD-control unit 14.

Use time setting unit 11 stores a use start time and a use end time for each of HDDs 3, supplied from input device 5, in use time memory unit 21. The use start time refers to the time from which access can be made to targeted HDD 3. The use end time refers to the time from which accesses are no longer made to targeted HDD 3. Accordingly, host 4 accesses targeted HDD 3 only from the use start time to use end time. The use start time and use end time are values set by the user from input device 5.

Rotation control time determination unit 12 determines a rotation start time and a rotation stop time for each of HDDs 3 from the use start time and use end time stored in use time memory unit 21, and stores them in rotation control time memory unit 22. The rotation start time refers to a time at which a rotation start instruction is issued to start the rotation of targeted HDD 3. The rotation stop time refers to a time at which a rotation stop instruction is issued to stop the rotation of targeted HDD 3. The rotation start time and rotation stop time are collectively called the “rotation control time.” The rotation start time may be a time which is calculated by subtracting a predetermined margin from the use start time. The rotation stop time in turn may be a time which is calculated by subtracting a predetermined margin from the use end time.

Time determination unit 13 acquires a current time from clock 6 to determine that HDD 3 reaches a rotation start time or a rotation stop time stored in rotation control time memory unit 22. Then, time determination unit 13 transmits a rotation start instruction to HDD control unit 14 to start rotation of HDD 3 which has reached the rotation start time. Also, time determination unit 13 transmits a rotation stop instruction to HDD control unit 14 to stop the rotation of HDD 3 which has reached the rotation stop time.

HDD control unit 14 issues the rotation start instruction and rotation stop instruction received from time determination unit 13 to relevant HDD 3. HDD control unit 14 also transfers commands and data between host 4 and HDDs 3.

Memory unit 2 comprises use time memory unit 21 and rotation control time memory unit 22.

Use time memory unit 21 stores a use start time and use end time for each HDD 3.

Rotation control time memory unit 22 stores the rotation start time and rotation stop time for each HDD 3.

HDD 3 transmits/receives a command and data to/from host 4 through HDD control unit 14 to write data into and read data from the disk. The disk must be previously rotated in order to access the same, so that HDD 3 also controls the rotation of the disk. Upon receipt of a rotation start instruction from HDD control unit 14, HDD 3 starts rotating the disk. On the other hand, upon receipt of a rotation stop instruction from HDD control unit 14, HDD 3 stops rotating the disk.

Host 4 transmits/receives a command and data to/from HDD 3 through HDD control unit 14.

Input device 5 notifies use time setting unit 11 of a use start time and a use end time for each of HDDs 3, entered by the user.

Clock 6 provides the current time to time determination unit 13.

In the following description, number x is used to identify one of a plurality of HDDs 3, and individual HDD 3 is labeled HDD[x]. Also, the total number of HDDs 3 is represented by Max. Specifically, individual HDDs 3 are represented by HDD[1] to HDD[Max]. Also, a use start time for HDD[x] is represented by use start time [x]; a use end time for HDD[x] by HDD[x] by use end time[x]; a rotation start time for HDD[x] by rotation start time [x]; and a rotation stop time for HDD[x] by rotation stop time [x].

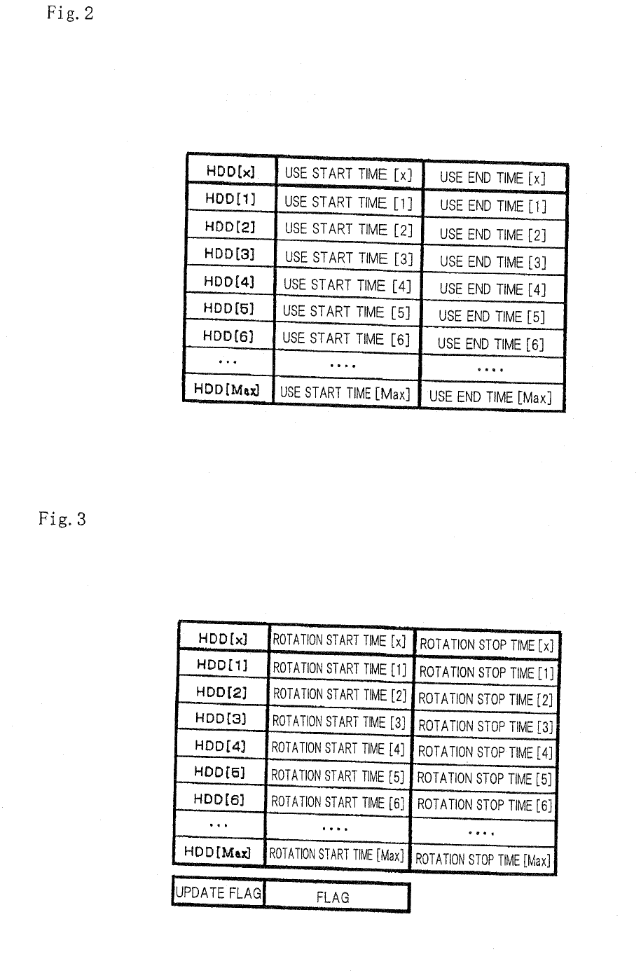

FIG. 2 is a table showing information recorded in use time memory unit 21 in the first exemplary embodiment. Referring to FIG. 2, use time memory unit 21 records the use start time and use end time on a HDD-by-HDD basis. FIG. 3 is a table showing information recorded in rotation control time memory unit 22 in the first exemplary embodiment. Referring to FIG. 3, rotation control time storage unit 22 records the rotation start time and rotation stop time on a HDD-by-HDD basis, and also record an update flag indicating that the information has been updated.

Next, a description will be given of the overall operation of the system in this exemplary embodiment. The overall operation of the system mainly comprises a rotation control time determination process and an HDD control process. The rotation control time determination process and HDD control process are performed in parallel or substantially in parallel.

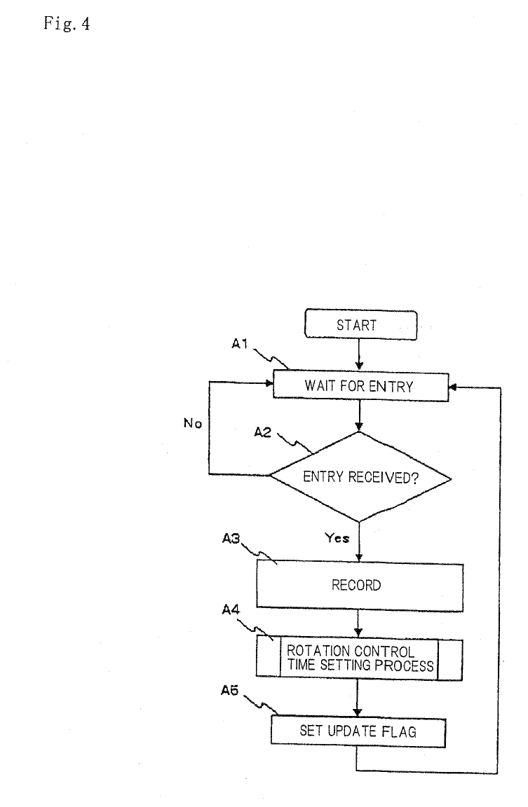

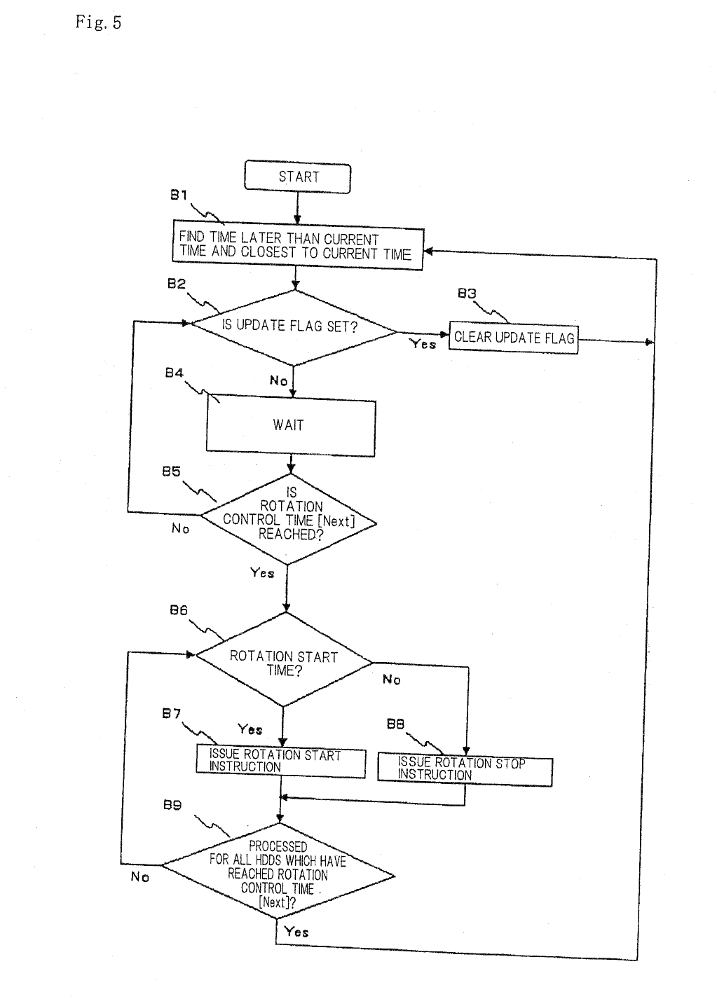

FIG. 4 is a flow chart illustrating the rotation control time determination process in the first exemplary embodiment. FIG. 5 is a flow chart illustrating the HDD control process in the first exemplary embodiment.

Referring to FIG. 4, in the rotation control time determination process, use time setting unit 11 first waits for an entry from input device 5 (step A1), and determines the presence or absence of an entry (step A2). When either a use start time or a use end time is not entered, use time setting unit 11 returns to step A1.

When either a use start time or a use end time is entered from input device 5, use time setting unit 11 records the entered use start time or use end time in the corresponding area of use time memory unit 21 (step A3). In this event, when the entered use start time is intended, for example, for HDD[1], the entered value is stored as use start time [1] in a table in use time memory unit 21 shown in FIG. 2. On the other hand, when the entered use end time is intended for HDD[2], the entered value is stored as use end time [2] in the table in use time memory unit 21.

Next, rotation control time determination unit 12 performs a rotation control time setting process (step A4). The rotation control time setting process involves determining rotation start times and rotation stop times for all HDDs 3 from use start times and use end times stored in use time memory unit 21, and recording the determined times in rotation control time memory unit 22. Details of the rotation control time setting process will be described later.

Next, rotation control time determination unit 12 sets an update flag in rotation control time memory unit 22 (step A5), and returns to step A1.

Referring to FIG. 5, in the HDD control process, time determination unit 13 first acquires the current time from clock 6, searches the rotation start times and rotation stop times stored in rotation control time memory unit 22 for a time later than the current time and closest to the current time (step B1), and sets the found time to rotation control time [Next].

Next, time determination unit 13 determines whether or not the update flag is set in rotation control time memory unit 22 (step B2). When the update flag is set, time determination unit 13 clears the update flag (step B3), and returns to step B1.

When the update flag is not set at step B2, time determination unit 13 waits until rotation control time [Next] is reached (step B4), and determines whether or not rotation control time [Next] is reached (step B5). When the current time does not match rotation control time [Next], the time determination unit 13 returns to step B2.

When the current time matches rotation control time [Next], time determination unit 13 determines whether or not rotation control time [Next] is equal to rotation start time [Next] (step B6).

When rotation control time [Next] is equal to rotation start time, time determination unit 13 issues a rotation start instruction to relevant HDD 3 through HDD control unit 14 (step B7). When rotation control time [Next] is equal to a rotation stop time at step B6, time determination unit 13 issues a rotation stop instruction to relevant HDD 3 through HDD control unit 14 (step B8).

Next, time determination unit 13 determines whether or not the (instruction issuing) processing has been completed for all HDDs 3 which had reached rotation control time [Next] (step B9). If the processing has not been completed for all HDDs 3 which reached rotation control time [Next], time determination unit 13 returns to step B6 to perform processing for remaining HDDs 3. On the other hand, when processing has been completed for all HDDs 3 which reached rotation control time [Next], time determination unit 13 returns to step B1.

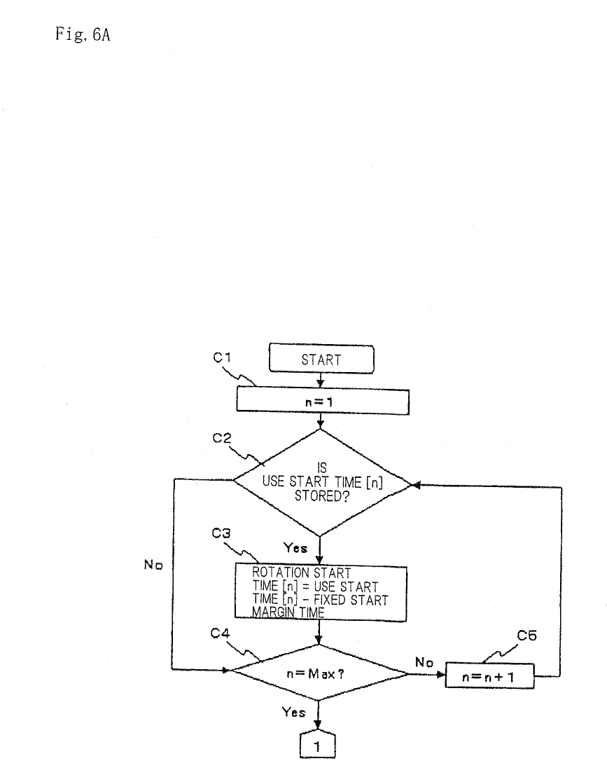

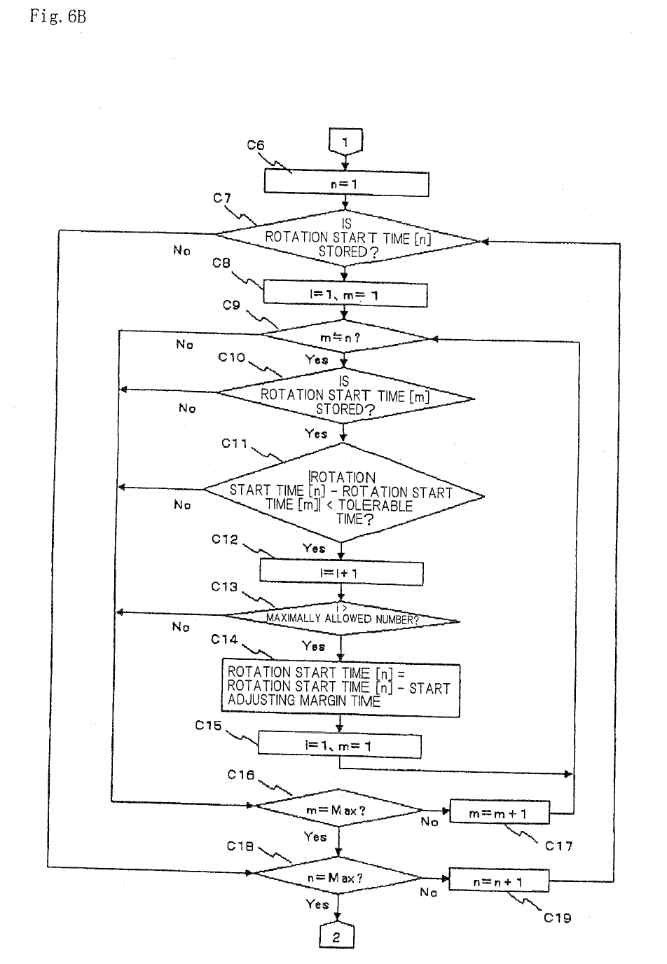

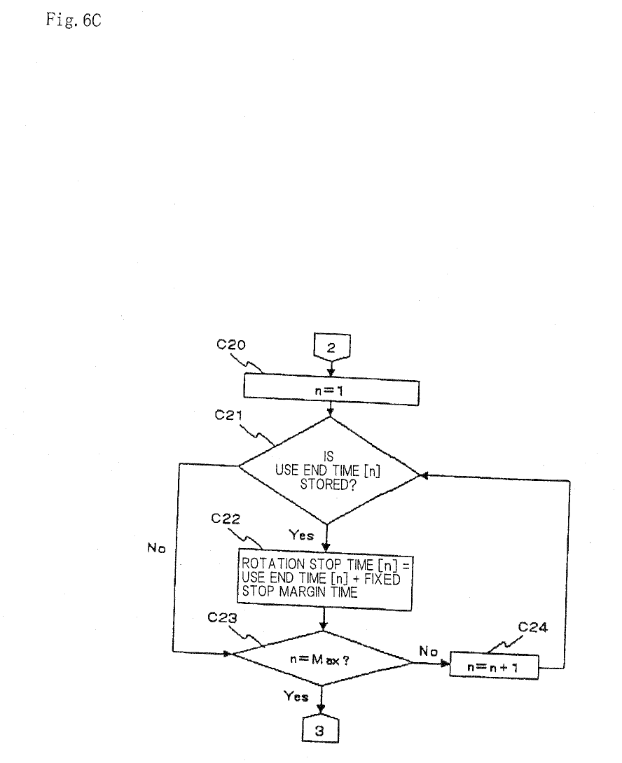

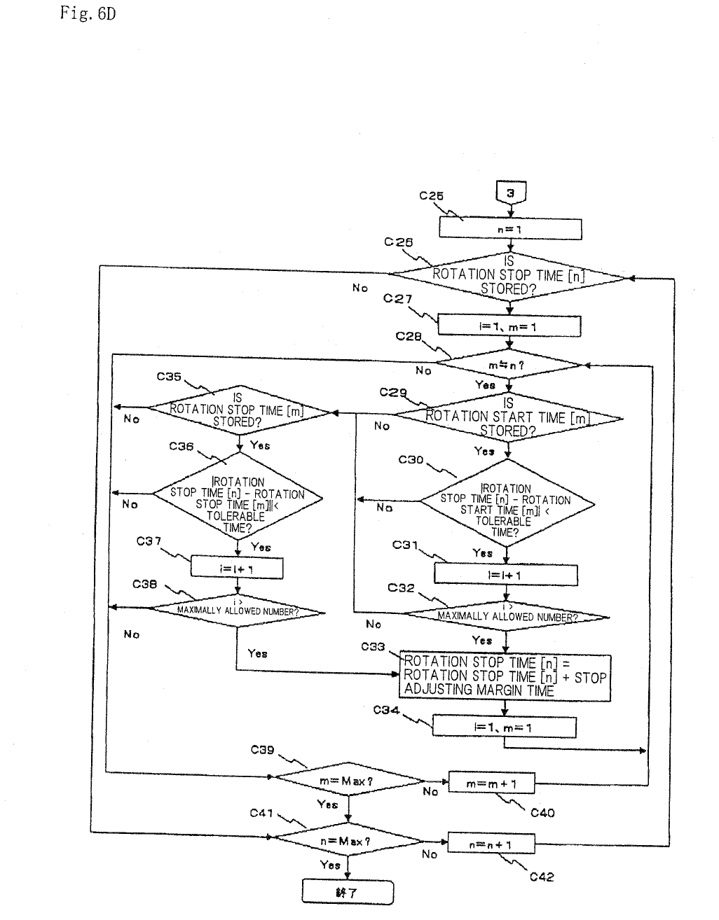

FIGS. 6A-6D are flow charts illustrating details of the rotation control time setting process shown at step A4 in FIG. 4. The rotation control time setting process comprises a fixed start margin time setting process (FIG. 6A), a start adjusting margin time setting process (FIG. 6B), a fixed stop margin time setting process (FIG. 6C), and a stop adjusting margin time setting process (FIG. 6D).

In FIG. 6A, n represents the identifier of HDD 3 which undergoes the fixed start margin time setting process.

In FIG. 6B, n represents the identifier of HDD 3 which undergoes the start adjusting margin time setting process, and m represents the identifier of HDD 3, the rotation start time of which is compared for setting a start adjusting margin time. Further, in FIG. 6B, i represents a value for counting the number of HDDs 3 during the process.

In FIG. 6C, n represents the identifier of HDD 3 which undergoes the fixed stop margin time setting process.

In FIG. 6D, n represents the identifier of HDD 3 which undergoes the stop adjusting margin time setting process, and m represents the identifier of HDD 3, the rotation start time and rotation stop time of which are compared for setting a stop adjusting margin time. Further, in FIG. 6D, i represents a value for counting the number of HDDs during the process.

First, the fixed start margin time setting process will be described in connection with FIG. 6A. Referring to FIG. 6A, rotation control time determination unit 12 initially sets identifier n of a target HDD which undergoes the fixed start margin time setting process to 1 (step C1) to specify rotation start time [1] for which a fixed start margin time is set.

Next, rotation control time determination unit 12 checks whether or not use start time [n] is stored in use time memory unit 21 (step C2). When use start time [n] is stored, rotation control time determination unit 12 subtracts the fixed start margin time from use start time [n] to calculate rotation start time [n] which is then recorded in rotation control time memory unit 22 (step C3). Here, the fixed start margin time refers to a margin for taking into consideration the time required to activate a disk, and has been previously set longer than the time required to activate the disk. The fixed start margin time may be the same for all HDDs 3.

Next, rotation control time determination unit 12 checks whether or not n is equal to Max (step C4). When n is not equal to Max, rotation control time determination unit 12 specifies rotation start time [n+1] which undergoes the fixed start margin time setting process the next time (step C5), and performs processing from step C2 onward.

At step C2, when use start time [n] is not stored in use time memory unit 21, rotation control time determination unit 12 proceeds to step C4.

Rotation control time determination unit 12 repeats processing at steps C2-C5 to calculate the rotation start times for all HDDs 3, whose use start times are stored in use time memory unit 21, and records the calculated rotation start times in rotation control time memory unit 22.

At step C4, when n is equal to Max, rotation control time determination unit 12 terminates the fixed start margin time setting process, and proceeds to the start adjusting margin time setting process.

Next, the start adjusting margin time setting process will be described in connection with FIG. 6B. Referring to FIG. 6B, rotation control time determination unit 12 initially sets identifier n of a target HDD which undergoes the start adjusting margin time setting process to 1 (step C6) to specify rotation start time [1] for which a start adjusting margin time is set.

Next, rotation control time determination unit 12 checks whether or not rotation start time [n] is stored in rotation control time memory unit 22 (step C7). When rotation start time [n] is stored in rotation control time memory unit 22, rotation control time determination unit 12 sets identifier m of HDD 3 which is compared with the target HDD to 1, to determine that rotation start time [1] is compared operation start time [n], and sets HDD count value i to 1 (step C8).

Subsequently, rotation control time determination unit 12 compares m with n to check whether or not the target HDD which undergoes the start adjusting margin time setting process is different from the compared HDD (step C9). When m is different from n, rotation control time determination unit 12 checks whether or not rotation start time [m] is stored in rotation control time memory unit 22 (step C10).

When rotation start time [m] is stored in rotation control time memory unit 22, rotation control time determination unit 12 checks whether or not the difference between rotation start time [n] and rotation start time [m] is smaller than the allowed time (step C11). The allowed time is a predefined time length which is set to a value larger than either the time required to activate a disk or the time required to stop the disk. The same allowed time may be set for all combinations of HDDs.

When the difference between rotation start time [n] and rotation start time [m] is smaller than the allowed time, rotation control time determination unit 12 adds one to count value i (step C12), and checks whether or not i is larger than a maximally allowed number (step C13). The maximally allowed number is set such that the consumed current does not exceed the value allowed for the device even if the maximally allowed number of HDDs 3 simultaneously start activating or stopping their disks while all other HDDs 3 are rotating their disks.

When i is larger than the maximally allowed number, rotation control time determining unit 12 subtracts the start adjusting margin time from rotation start time [n] stored in rotation control time memory unit 22 to calculate rotation start time [n] which is then recorded in rotation control time memory unit 22 (step C14), sets i=1 and m=1, and returns to step C9 to perform processing from step C9 onward. The start adjusting margin time is a margin for taking into consideration the time required to activate a disk, and is previously set longer than the time required to activate a disk.

When m is the same as n at step C9, or when rotation start time [m] is not stored in rotation control time memory unit 22 at step C10, or when the difference between rotation start time [n] and rotation start time [m] is equal to or larger than the allowed time at step C11, or when i is not larger than the maximally allowed number at step C13, rotation control time determination unit 12 checks whether or not m is equal to Max (step C16).

When m is not equal to Max, rotation control time determination unit 12 adds one to m (step C17), and returns to step C9 to perform processing from step C9 onward.

When rotation start time [n] is not stored in rotation control time memory unit 22 at step C7, or when m is equal to Max at step C16, rotation control time determination unit 12 checks whether or not n is equal to Max (step C18). When n is not equal to Max, rotation control time determination unit 12 adds one to n (step C19), and returns to step C7 to perform processing from step C7 onward. When n is equal to Max, rotation control time determination unit 12 terminates the start adjusting margin time setting process, and proceeds to the stop adjusting margin time setting process.

Next, the fixed stop margin time setting process will be described in connection with FIG. 6C. Referring to FIG. 6C, rotation control time determination unit 12 initially sets identifier n of a target HDD which undergoes the fixed stop margin time setting process to 1 (step C20) to specify rotation stop time [1] for which a fixed stop margin time is set. Next, rotation control time determination unit 12 checks whether or not use end time [n] is stored in use time memory unit 21 (step C21). When use end time [n] is stored, rotation control time determination unit 12 adds the fixed stop margin time to use end time [n] to calculate rotation stop time [n] which is then recorded in rotation control time memory unit 22 (step C22). The fixed stop margin time is a predefined time length which is set to a value larger than zero. The fixed stop margin time may be the same time for all HDDs 3.

Next, rotation control time determination unit 12 checks whether or not n is equal to Max (step C23). When n is not equal to Max, rotation control time determination unit 12 specifies rotation stop time [n+1] for which the fixed stop margin time is next set (step C24), returns to step C21 to perform processing from step C21 onward.

When use stop time [n] is not stored in use time memory unit 21 at step C21, rotation control time determination unit 12 proceeds to step C23.

Rotation control time determination unit 12 repeats processing at steps C21-C24 to calculate rotation stop times for all HDD 3, the use end times of which are stored in use time memory unit 21, and stores the calculated rotation stop times in rotation control time memory unit 22.

When n is equal to Max at step C23, rotation control time determination unit 12 terminates the fixed stop margin time setting process, and proceeds to the stop adjusting margin time setting process.

Next, the stop adjusting margin time setting process will be described in connection with FIG. 6D. Referring to FIG. 6D, rotation control time determination unit 12 initially sets identifier n of a target HDD which undergoes the stop adjusting margin time setting process (step C25) to specify rotation stop time [1] for which the stop adjusting margin time is set.

Next, rotation control time determination unit 12 checks whether or not rotation stop time [n] is stored in rotation control time memory unit 22 (step C26). When rotation stop time [n] is stored, rotation control time determination unit 12 sets identifier m of HDD 3 which is compared with the target HDD to 1 to determine that rotation start time [1] is compared with rotation stop time [n], and sets HDD count value i to 1 (step C27).

Next, rotation control time determination unit 12 compares m with n to check whether or not the target HDD which undergoes the start adjusting margin time setting process is different from the HDD which is involved in the comparison (step C28). When m is different from n, rotation control time determination unit 12 checks whether or not rotation start time [m] is stored in rotation control time memory unit 22 (step C29). When rotation start time [m] is stored in rotation control time memory unit 22, rotation control time determination unit 12 checks whether or not the difference between rotation stop time [n] and rotation start time [m] is smaller than the allowed time (step C30). The allowed time used herein is the same as that used at step C11.

When the difference between rotation stop time [n] and rotation start time[m] is smaller than the allowed time, rotation control time determination unit 12 adds one to count value i (step C31), and checks whether or not i is larger than the maximally allowed number (step C32). The maximally allowed number used herein is the same as that used at step C13.

When i is larger than the maximally allowed number, rotation control time determination unit 12 adds the stop adjusting margin time to rotation stop time [n] stored in rotation control time memory unit 22 to calculate rotation stop time [n] which is then recorded in rotation control time memory unit 22 (step C33).

Subsequently, rotation control time determination unit 12 sets i=1 and m=1, and returns to step C28 to perform processing from step C28 onward. The stop adjusting margin time is a margin for taking into consideration the time required to stop a disk, and is previously set longer than the time required to stop a disk.

When rotation start time [m] is not stored in rotation control time memory unit 22 at step C29, or when the difference between rotation stop time [n] and rotation start time [m] is equal to or larger than the allowed time at step C30, or when i is equal to or smaller than the maximally allowed number at step C32, rotation control time determination unit 12 checks whether or not rotation stop time [m] is stored in rotation control time memory unit 22 (step C35).

When rotation stop time [m] is stored in rotation control time memory unit 22, rotation control time determination unit 12 checks whether or not the difference between rotation stop time [n] and rotation stop time [m] is smaller than the allowed time (step C36). The value of the allowed time at step C36 is the same as the allowed time at step C30.

When the difference between rotation stop time [n] and rotation stop time [m] is smaller than the allowed time, rotation control time determination unit 12 adds one to count value i (step C37), and checks whether or not i is larger than the maximally allowed number (step C38). The maximally allowed number at step C38 is the same as the maximally allowed number at step C32. When i is larger than the maximally allowed number, rotation control time determination unit 12 proceeds to step C33.

When rotation stop time [m] is not stored in rotation control time memory unit 22 at step C35, or when the difference between rotation stop time [n] and rotation stop time [m] is equal to or larger than the allowed time at step C36, or when i is equal to or smaller than the maximally allowed number at step C38, rotation control time determination unit 12 checks whether or not m is equal to Max (step C39). When m is not equal to Max, rotation control time determination unit 12 adds one to m (step C40), and returns to step C28 to perform processing from step C28 onward.

When rotation stop time [n] is not stored in rotation control time memory unit 22 at step C26, or when m is equal to Max at step C39, rotation control time determination unit 12 checks whether or not n is equal to Max (step C41). When n is not equal to Max, rotation control time determination unit 12 adds one to n (step C40), and returns to step C26 to perform processing from step C26 onward. When n is equal to Max, rotation control time determination unit 12 terminates the rotation control time setting process.

According to the foregoing fixed start margin time setting process (FIG. 6A) and start adjusting margin time setting process (FIG. 6B), the rotation start times are determined for all HDDs 3, the use start times of which are stored in use time memory unit 21, and recorded in rotation control time memory unit 22.

Next, a description will be given of a specific example of operations performed by rotation control time determination unit 12 for determining rotation start times and rotation stop times.

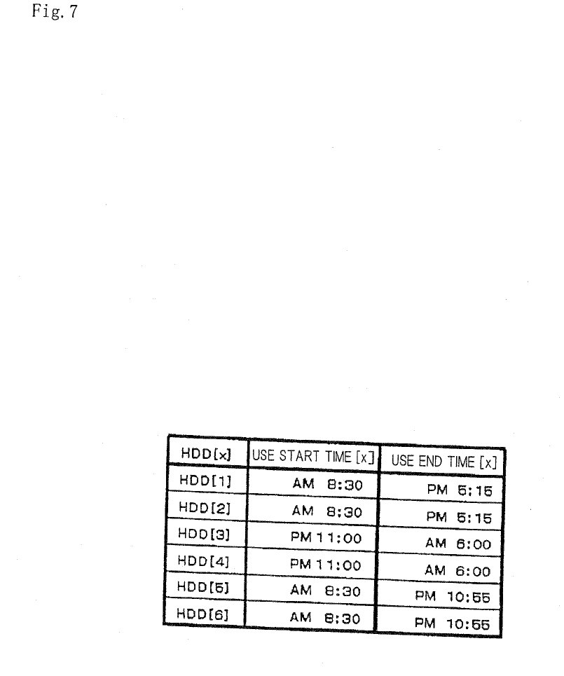

In this example, assume that the number of HDDs 3 is six, i.e., Max=6. Assume also that the fixed start margin time is set to two minutes; start adjusting margin time to two minutes; fixed stop margin time to three minutes; stop adjusting margin time to two minutes, allowed time to one minute; and maximally allowed number to two. FIG. 7 is a table showing an example of use start times and use end times stored in use time memory unit 21. Assume that use time memory unit 21 stores the use start times shown in FIG. 7.

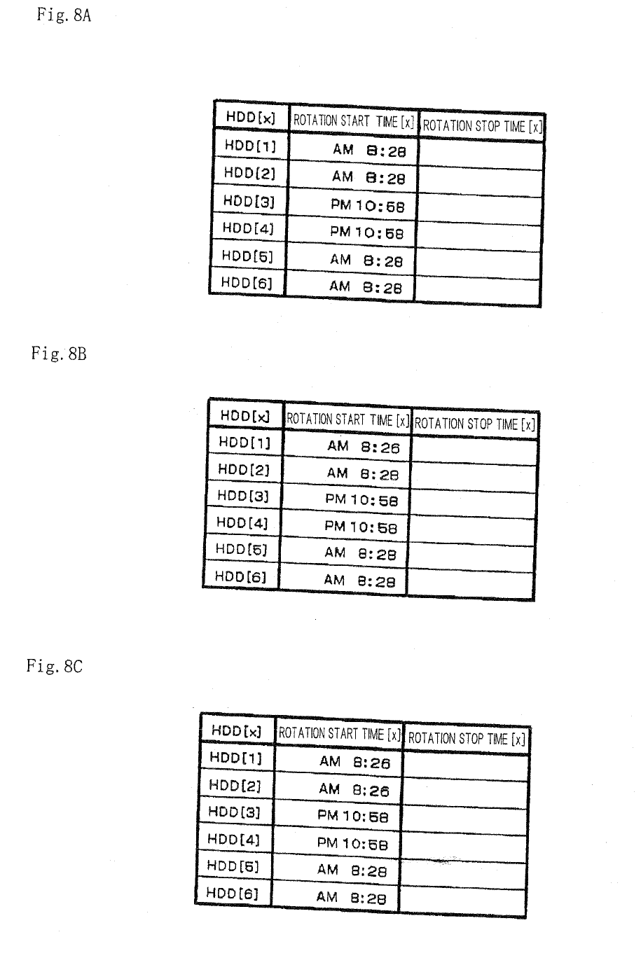

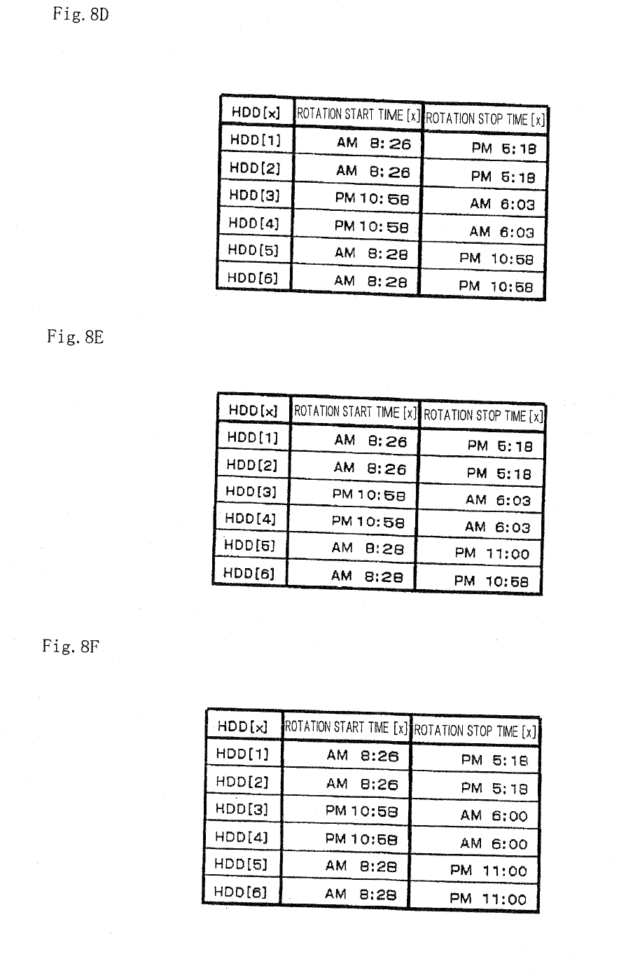

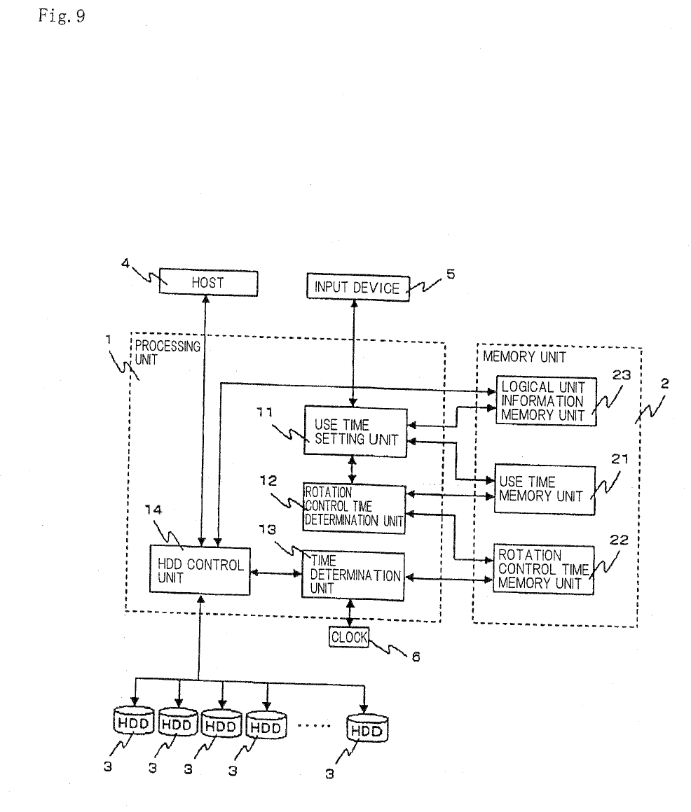

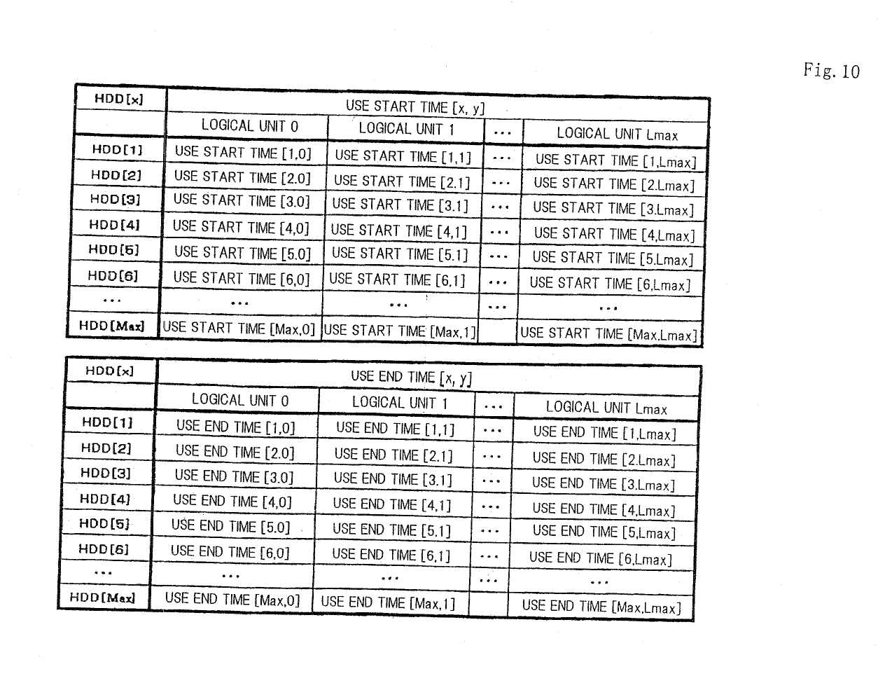

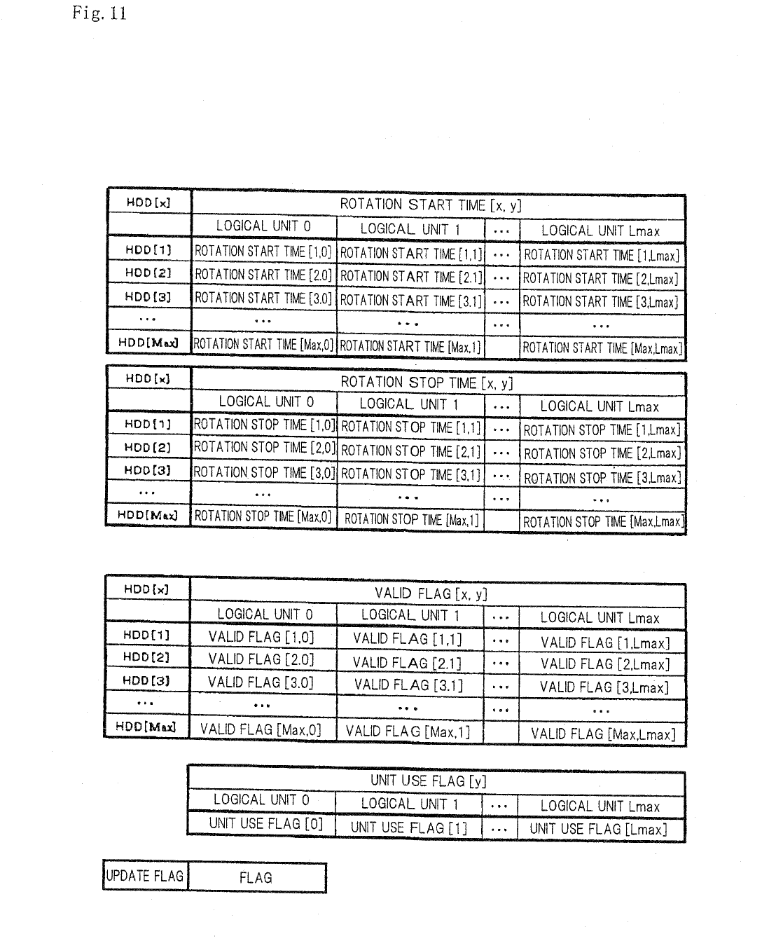

First, the fixed start margin time setting process (steps C1-C5) sets a time earlier by the fixed start margin time, i.e., two minutes earlier than the use start time to the rotation start time of each of HDD[1] to HDD[6]. FIG. 8A is a table showing a first example of rotation control times which are set in rotation control time memory unit 22 in the first exemplary embodiment. Referring to FIG. 8A, times that are earlier by two minutes than the use start times shown in FIG. 7 are set as the rotation start times of HDD[1] to HDD[6].

Next, rotation control time determination unit 12 sets n to one (step C6), and executes processing at steps C7-C17, causing rotation start time [1] to be earlier by the start adjusting margin time, i.e. two minutes. FIG. 8B is a table showing a second example of rotation control times set in rotation control time memory unit 22 in the first exemplary embodiment. Referring to FIG. 8B, rotation start time [1] is set at AM 8:26 which is earlier by the start adjusting margin, i.e., two minutes earlier than that shown in FIG. 8A.

Next, rotation control time determination unit 12 sets n to two (steps C18-C19), and executes processing at steps C7-C17, causing rotation start time [2] to be earlier by the start adjusting margin time, i.e., two minutes. FIG. 8C is a table showing a third example of rotation control times set in rotation control time memory unit 22 in the first exemplary embodiment. Referring to FIG. 8C, rotation start time [2] is set at AM 8:26 which is earlier by the start adjusting margin time, i.e., two minutes earlier than that shown in FIG. 8B.

Next, rotation control time determination unit 12 sets n to three (steps C18-C19), and executes the processing at steps C7-C17. Here, rotation start time [3] does not change, and remains at AM 10:58. Subsequently, rotation control time determination unit 12 sets n to 4, 5, 6, and executes processing at steps C18 C19, however, without causing any change in rotation start time [4], rotation start time [5], and rotation start time [6].

In this example, since n becomes equal to Max at this time (step C18), rotation control time determination unit 12 terminates the process for determining the rotation start times. As a result, the values shown in FIG. 8C are stored in rotation control time memory unit 22.

Next, the fixed stop margin time setting process (steps C20-C24) sets times later by the fixed stop margin time, i.e., three minutes added to the rotation stop times of HDD[1] to HDD[6]. FIG. 8C is a table showing a fourth example of rotation control times set in rotation control time memory unit 22 in the first exemplary embodiment. Referring to FIG. 8D, times later by three minutes than the use start times shown in FIG. 7 are set for the rotation stop times of HDD[1] to HDD[6].

Next, rotation control time determination unit 12 sets n to one (step C25), and executes processing at steps C26-C40 to determine the value of rotation stop time [1] at PM 5:18 without change. Subsequently, when rotation control time determination unit 12 sets n to 2, 3, 4 (steps C41-C42), and executes steps C26-C40, the values of rotation stop time [2], rotation stop time [3], and rotation stop time [4] do not change but remain as shown in FIG. 8D.

Next, rotation control time determination unit 12 sets n to 5 (steps C41-C42), and executes steps C26-C40, causing rotation stop time [5] to be later by the amount of the stop adjusting margin time, i.e., two minutes. FIG. 8E is a table showing a fifth example of rotation control times set in rotation control time memory unit 22. Referring to FIG. 8E, rotation stop time [5] is set at PM 11:00 which is two minutes later than the use start time shown in FIG. 8D.

Next, rotation control time determination unit 12 sets n to six (steps C41-C42), and executes the processing at steps C26-C40, causing rotation stop time [6] to be later by the amount of the stop adjusting margin time, i.e., two minutes. FIG. 8F is a table showing a sixth example of rotation control times set in rotation control time memory unit 22. Referring to FIG. 8F, rotation stop time [6] is set at PM 11:00 which is two minutes later than the use start time shown in FIG. 8E.

By starting and stopping the rotation of HDDs 3 in accordance with the eventually determined rotation start times and rotation stop times in FIG. 8F, a number of HDDs 3 exceeding two, which is the maximally allowed number, are prevented from simultaneously being activated or stopped. It is possible to restrain the concentration of activating operation and stopping operation and to control the rotating states of disks such that the consumed current does not exceed the allowed current value.

While time is processed in minutes in the example shown above, the present invention is not so limited. In another exemplary embodiment, time may be processed in smaller units such as seconds.

Also, whereas the foregoing exemplary embodiment shows an example in which one use start time and use end time is set for each HDD, and one rotation start time and one rotation stop time is calculated for each HDD, the present invention is not so limited-. In another example, the present invention may be extended to set a plurality of use start times and use end times and to calculate a plurality of rotation start times and rotation stop times.

As described above, since the disk is rotated and maintained in an accessible state from the use start time to the use end time, previously set for each HDD 3, and since the disk is stopped in the remaining time zone, the system according to this exemplary embodiment can accomplish both a reduction in power consumption and a fast response when accessed. In addition, in this exemplary embodiment, the rotation start time and rotation stop time of each HDD 3 are adjusted to limit the number of HDDs 3 which are simultaneously activated or stopped, thus making it possible to prevent power consumption from exceeding the allowance of the device.

Also, in this exemplary embodiment, since the rotation start time and rotation stop time of each HDD are adjusted according to a mutual relationship of the use start time and use end time of each HDD 3, the user enters the use start time and use end time of a certain HDD 3 without the need for considering the use start times and use end times of other HDDs 3.

### Second Embodiment

FIG. 9 is a block diagram illustrating a system according to a second exemplary embodiment. The system of the second exemplary embodiment illustrated in FIG. 9 comprises logical unit information memory unit 23 in addition to the components of the first exemplary embodiment illustrated in FIG. 1.

A logical unit refers to a unit of storage to which access is made by host 4. Also, the logical unit conceptually conceals the configuration of HDDs 3 to host 4, and one logical unit may extend across a plurality of HDDs 3. In this event, the logical unit may comprise RAID (Redundant Arrays of Independent Disks) of HDDs 3. Alternatively, the address space of one HDD 3 may be divided into a plurality of logical units.

Logical unit information memory unit 23 stores information (logical unit information) such that the logical units corresponds to HDDs 3.

In this exemplary embodiment, the user can set a use start time and a use end time for each logical unit from input device 5. The use start time refers to a time from which HDD 3 can be accessed as an access to a relevant logical unit from the host, while the use end time refers to a time from which HDD 3 is not accessed as an access to a relevant logical unit from the host.

Use time setting unit 11 records a use start time and use end time for each logical unit on an HDD-by-HDD basis. Upon receipt of the use start time and use end time of a certain logical unit (hereinafter called the “target logical unit”) from input device 5, use time setting unit 11 examines HDD 3 corresponding to the target logical unit (hereinafter called the “target HDD”) based on the logical unit information stored in logical unit information memory unit 23. Then, use time setting unit 11 records the use start time and use end time supplied from input device 5 in use time memory unit 21 as a use start time and a use end time of the target logical unit in the resulting target HDD.

Use time memory unit 21 stores the use start time and use end time for each of all logical units which are in a correspondence relationship to HDDs 3 on an HDD-by-HDD basis.

Rotation control time determination unit 12 determines a rotation start time and a rotation stop time for each logical unit in each HDD 3 from the use start time and use end time stored in use time memory unit 21, and records the determined rotation start time and rotation stop time in rotation control time memory unit 22.

Rotation control time memory unit 22 records a rotation start time and a rotation stop time for each of all logical units included in each HDD 3. The rotation start time refers to a time at which a rotation start instruction is issued for starting the rotation of HDD 3. The rotation stop time refers to a time at which a rotation stop instruction is issued for stopping the rotation of HDD 3.

Rotation control time memory unit 22 also stores logical unit information, as a valid flag, which indicates a relationship between HDD 3 and a logical unit, the rotation control time of which is recorded therein. The valid flag, which is provided for each of the logical units included in each HDD 3 on an HDD-by-HDD basis, indicates that HDD 3 includes at least part of a logical unit, and the rotation control time is set for the logical unit. When the logic flag is set for a certain logical unit in a certain HDD 3, this indicates that this HDD 3 includes at least part of the logical unit, and the rotation control time is set for this logical unit.

Rotation control time memory unit 22 further stores a unit use flag for each logical unit, which indicates whether or not the logical unit is accessible. When the unit use flag is set, this indicates that the logical unit associated therewith is accessible. An accessible state of a logical unit refers to a state in which a disk is rotating in HDD 3 which includes the logical unit.

Time determination unit 13 acquires the current time from clock 6, and transmits a rotation start instruction to HDD control unit 14 for starting the rotation of HDD 3 which reaches the rotation start time. Time determination unit 13 also sets the unit use flag associated with a relevant logical unit in rotation control time memory unit 22.

Time determination unit 13 also transmits a rotation stop instruction to HDD control unit 14 for stopping the rotation of HDD 3 which reaches a rotation stop time. Time determination unit 13 also clears the unit use flag associated with a relevant logical unit in rotation control time memory unit 22. In this event, when a certain logical unit reaches a rotation stop time (hereinafter called the “logical unit to be stopped”), time determination unit 13 references the valid flag and unit use flag stored in rotation control time memory unit 22 to check whether or not there is an accessible logical unit in other logical units included in HDD 3 (HDD to be stopped) which includes the logical unit to be stopped. When there is another accessible logical unit, HDD 3 cannot be stopped, so that time determination unit 13 does not transmit a rotation stop instruction to HDD control unit 14, and clears the unit use flag of the logical unit to be stopped. When there is not another accessible logical unit, time determination unit 13 transmits a rotation stop instruction to HDD control unit 14 to stop the HDD that is to be stopped.

HDD control unit 14 issues the rotation start instruction and rotation stop instruction received from time determination unit 13 to the relevant HDD 3. Also, in response to an access request from host 4, HDD control unit 14 transfers commands and data between host 4 and HDD 3 while converting the addresses of the logical unit and HDD 3 based on logical unit information stored in logical unit information memory unit 23,

In the following description, individual HDD3 is labeled HDD[x], where reference numeral x is used to identify one of a plurality of HDDs 3. Also, the total number of HDDs 3 is represented by Max. Specifically, individual HDDs 3 are labeled HDD[1] to HDD[Max]. Also, Lmax represents a value which is calculated by subtracting one from the maximum number of logical units which can be set. In this regard, logical units are numbered from zero.

Accordingly, the maximum number of logical units is represented by Lmax+1. Further, a use start time corresponding to logical unit y in HDD[x] is represented by use start time [x, y]; a use end time corresponding to logical unit y in HDD[x] by use end time [x, y]; a rotation stop time corresponding to logical unit y in HDD[x] by rotation stop time [x, y]; and rotation stop time corresponding to logical unit y in HDD[x] by rotation stop time [x, y]. Also, a valid flag corresponding to logical unit y in HDD[x] is represented by valid flag [x, y]. Valid flag [x, y] is set when HDD[x] corresponds to logical unit y, while valid flab [x, y] is cleared when HDD[x] not corresponds to logical unit y. Also, a unit use flag of logical unit y is represented by unit use flag [y]. Unit use flag [y] is set at a timing at which HDD 3 is made accessible to logical unit y, and is cleared at a timing at which HDD 3 is made inaccessible to logical unit y. The valid flag and access flag are used, for example, when two or more logical units are assigned to the same HDD 3, in order to determine that HDD 3 must be kept rotating in order to access another logical unit even when access is not required to one logical unit.

FIG. 10 is a table showing information recorded in use time memory unit 21 in the second exemplary embodiment. Referring to FIG. 10, use time memory unit 21 records a use start time and a use end time for each of logical units in each HDD. FIG. 11 is a table showing information recorded in rotation control time memory unit 22 in the second exemplary embodiment. Referring to FIG. 11, rotation control time memory unit 22 records a rotation start time, a rotation stop time, and a valid flag for each of the logical units in each HDD, also records a unit use flag for each logical unit, and further records a unit use flag for each logical unit.

The system of the second exemplary embodiment is similar in configuration to the first exemplary embodiment except for the components described above.

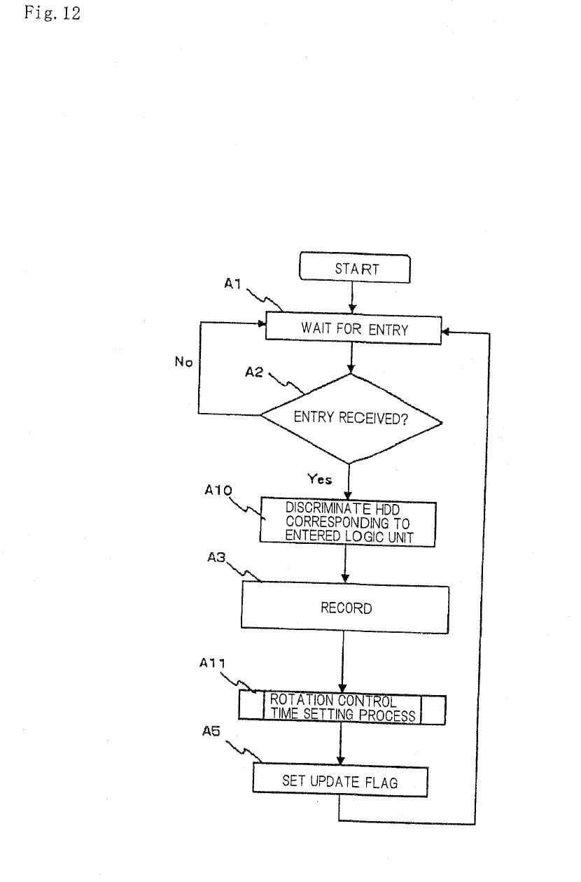

Next, a description will be given of the overall operation of the system of this exemplary embodiment, mainly in regard to differences with the first exemplary embodiment. FIG. 12 is a flow chart illustrating a rotation control time determination process in the second exemplary embodiment.

Referring to FIG. 12, the flow chart differs from the flow chart of the rotation control time determination process in the first exemplary embodiment illustrated in FIG. 4 in that when a use start time or a use end time is entered from input device 5 (step A2), use time setting unit 11 discriminates the corresponding HDDs 3 based on logical unit information stored in logical unit information memory unit 23 (step A10), and records use start times or use end times of the corresponding logical units in all corresponding HDDs 3.

Also, a rotation start time determination process (step A11) executed by rotation control time determination unit 12 to determine a rotation start time in the second exemplary embodiment differs in content from the rotation control time setting process (step A4 in FIG. 4) in the first exemplary embodiment. Details of the rotation control time setting process in the second exemplary embodiment will be described later.

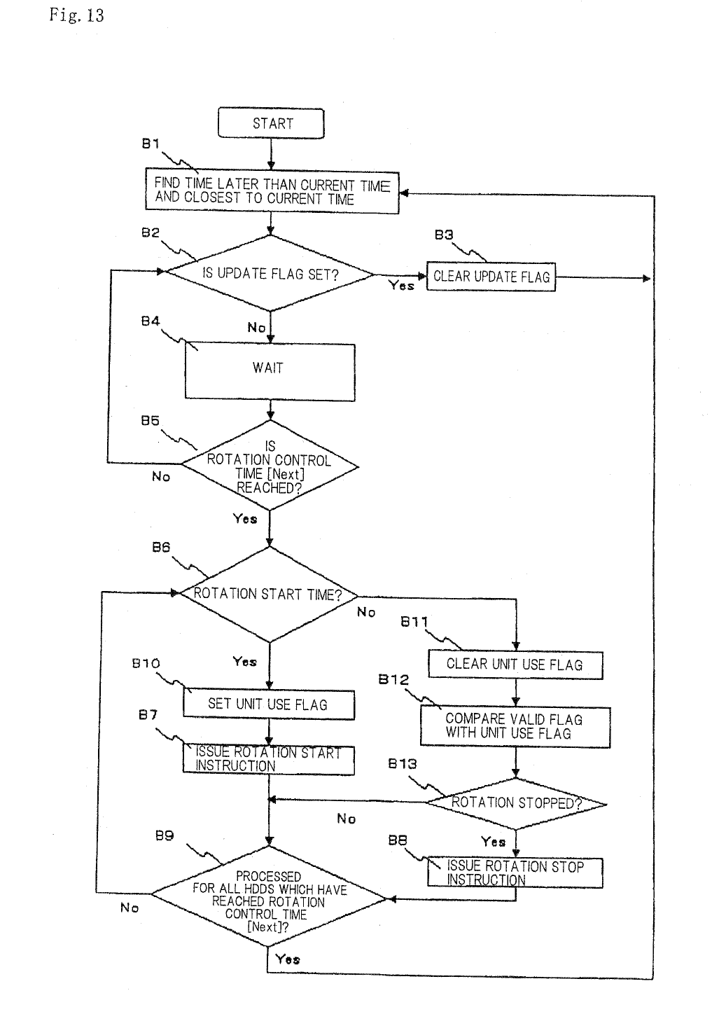

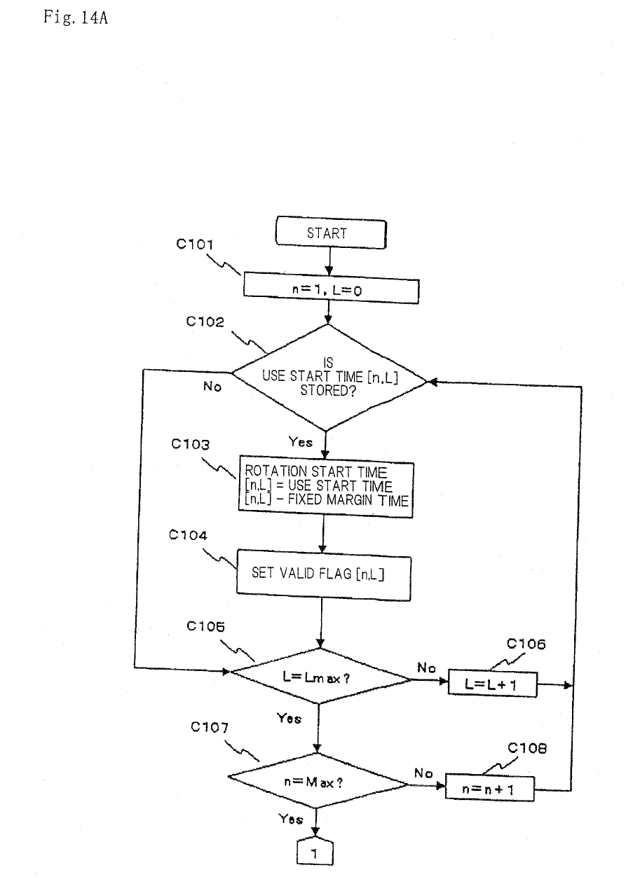

FIG. 13 is a flow chart illustrating an HDD control process in the second exemplary embodiment. Referring to FIG. 13, a description will be given of differences between the flow chart of FIG. 13 and the flow chart of the HDD control process in the first exemplary embodiment illustrated in FIG. 5.

In the second exemplary embodiment, when rotation control time [Next] is equal to the rotation start time at step B6, time determination unit 13 sets a unit use flag of a relevant logical unit (step B10), and issues a rotation start instruction (step B7). At step B10, time determination unit 13 sets valid flag [y], for example, when a time relevant to rotation control time [Next] is equal to rotation start time [x, y]. When valid flag [y] has been previously set, valid flag [y] is kept set.

On the other hand, when rotation control time [Next] is equal to the rotation stop time at step B6, time determination unit 13 clears the unit use flag (step B11), and compares the valid flag with the unit use flag of relevant HDD 3 (step B12). For example, when rotation control time [Next] is equal to rotation stop time [x, y], time determination unit 13 clears unit use flag [y] at step B11, and thoroughly compares valid flag [x, 0] with unit use flag [0], valid flag [x, 1] with unit use flag [1], . . . , valid flag [x, Lmax] with unit use flag [Lmax] at step B12. Then, if there is no combination of the flags which are both set, time determination unit 13 determines to stop the rotation of the disk of the relevant HDD 3. Upon determining that the rotation is stopped (step B13), time determination unit 13 issues a rotation stop instruction to relevant HDD 3 through HDD control unit 14 (step B8), and proceeds to step B9. Time determination unit 13 also proceeds to step B9 when it determines not to stop the rotation at step B13.

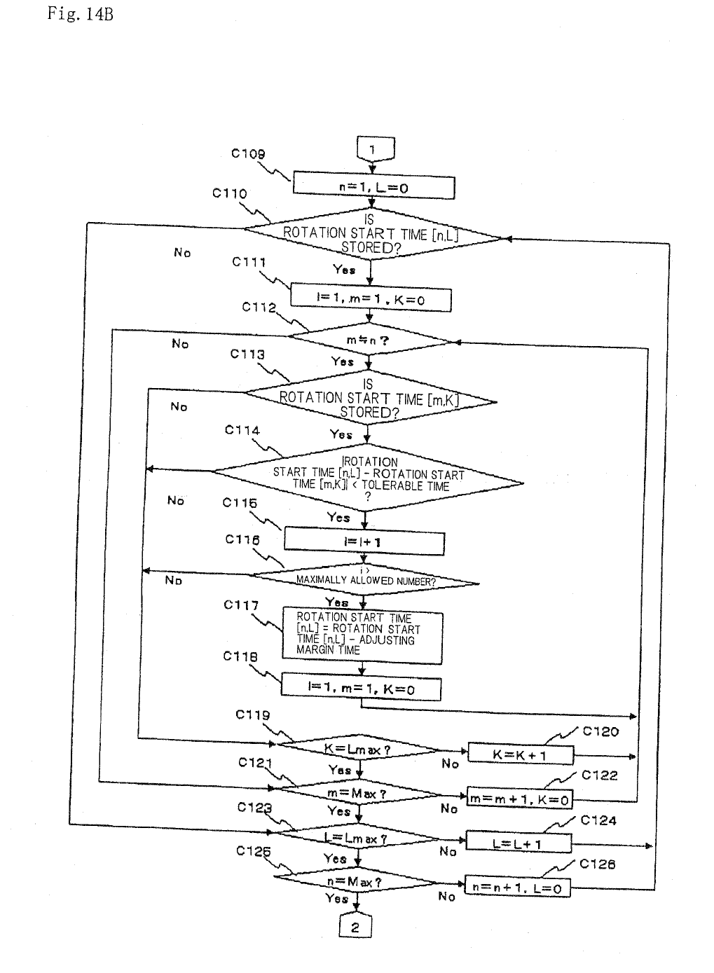

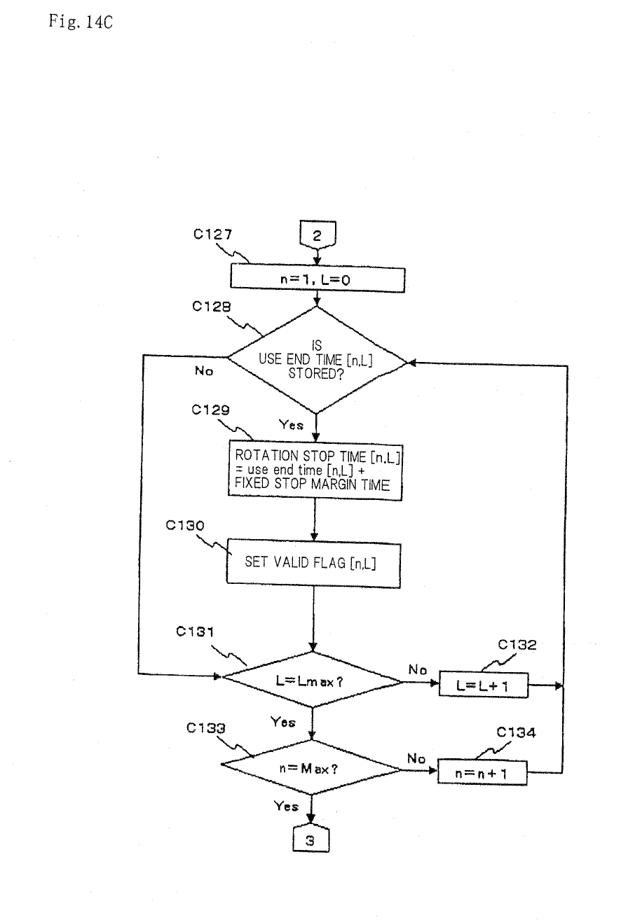

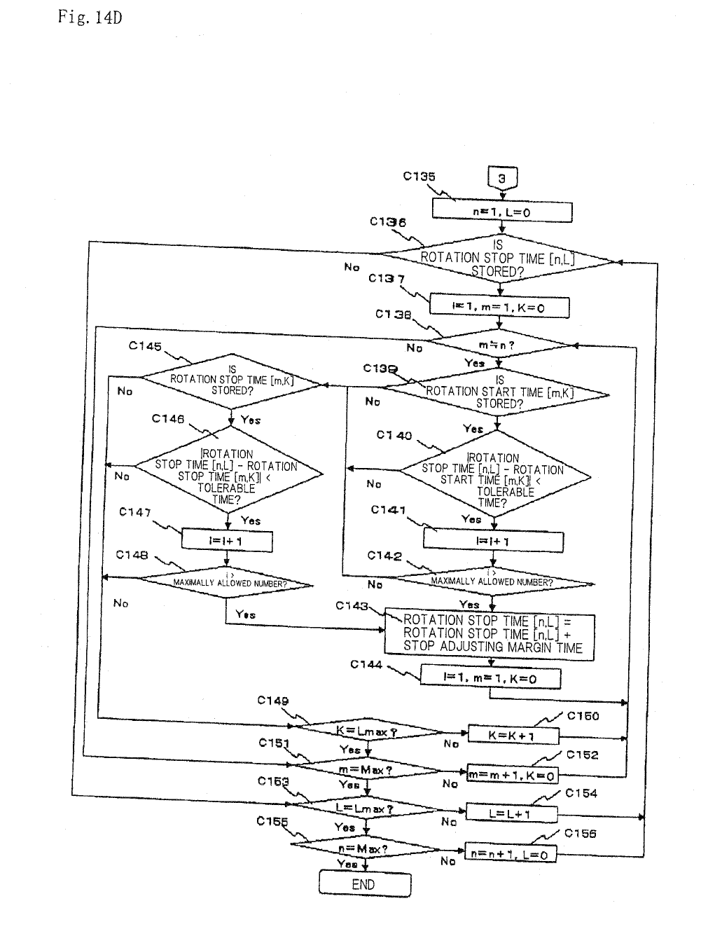

FIGS. 14A-14D are flow charts illustrating in detail the rotation control time setting process shown at step A11 in FIG. 12. The rotation control time setting process comprises a fixed start margin time setting process (FIG. 14A), a start adjusting margin time setting process (FIG. 14B), a fixed stop margin time setting process (FIG. 14C), and a stop adjusting margin time setting process (FIG. 14D).

In FIG. 14A, n represents the identifier of HDD 3 which undergoes the fixed start margin time setting process, and L represents the number of a logical unit which undergoes the fixed start margin time setting process.

In FIG. 14B, in turn, n represents the identifier of HDD 3 which undergoes the start adjusting margin time setting process; L represents the number of a logical unit which undergoes the start adjusting margin time setting process; m represents the identifier of HDD 3, whose rotation start time is compared for setting a start adjusting margin time; and K represents the number of a logical unit, whose rotation start time is compared for setting the start adjusting margin time. Further, in FIG. 14B, i represents a value for counting the number of HDDs during the process.

In FIG. 14C, in turn, n represents the identifier of HDD 3 which undergoes the fixed stop margin time setting process; and L represents the number of the logical unit which undergoes the fixed stop margin time setting process.

In FIG. 14D, in turn, n represents the identifier of HDD 3 which undergoes the stop adjusting margin time setting process; L represents the number of the logical unit which undergoes the stop adjusting margin time setting process; m represents the identifier of HDD 3, whose rotation start time and rotation stop time are compared for setting a stop adjusting margin time; and K represents the number of a logical unit, whose rotation start time and rotation stop time are compared for setting the stop adjusting margin time. Further, in FIG. 14D, i represents a value for counting the number of HDDs during the process.

First, the fixed start margin time setting process will be described in connection with FIG. 14A. Referring to FIG. 14A, rotation control time determination unit 12 initially sets identifier n of HDD 3 which undergoes the fixed start margin time setting process to 1, and sets number L of the logical unit which undergoes the fixed start margin time setting process to 0 (step C101) to specify rotation start time [1, 0] for which a fixed start margin time is set.

Next, rotation control time determination unit 12 checks whether or not use start time [n, L] is stored in use time memory unit 21 (step C102). When use start time [n, L] is stored, rotation control time determination unit 12 subtracts the fixed start margin time from use start time [n, L] to calculate rotation start time [n, L] which is then recorded in rotation control time memory unit 22 (step C103). Here, the fixed start margin time refers to a margin for taking into consideration the time required to activate the disk, and which has been previously set longer than the time required to activate the disk. The fixed start margin time may be the same for all HDDs 3.

Next, rotation control time determination unit 12 sets valid flag [n, L] in rotation control time memory unit 22 (step C104), and checks whether or not L is equal to largest logical unit number Lmax (step C105). When L is not equal to Lmax, rotation control time determination unit 12 adds one to L (step C106), and returns to step C102 to perform processing from step C102 onward.

When L is equal to Lmax at step C105, rotation control time determination unit 12 checks whether or not n is equal to Max (step C107). When n is equal to Max, rotation control time determination unit 12 adds one to n (step C108), and returns to step C102 to perform processing from step C102 onward.

When use start time [n, L] is not stored in use time memory unit 21 at step C102, rotation control time-determination unit 12 proceeds to step C105.

Rotation control time determination unit 12 repeats processing at steps C102-C108 to calculate rotation start times for all corresponding logical units in all HDDs 3, whose use start times of which are stored in use time memory unit 21, and records the calculated rotation start times in rotation control time memory unit 22. When n is equal to Max at step C107, rotation control time determination unit 12 terminates the fixed start margin time setting process, and proceeds to the start adjusting margin time setting process.

Next, the start adjusting margin time setting process will be described in connection with FIG. 14B. Referring to FIG. 14B, rotation control time determination unit 12 initially sets identifier n of HDD 3 which undergoes the start adjusting margin time setting process to 1, and sets number L of the logical unit which undergoes the start adjusting margin time setting process to 0 (step C109) to specify rotation start time [1, 0] for which a start adjusting margin time is set.

Subsequently, rotation control time determination unit 12 checks whether or not rotation start time [n, L] is stored in rotation control time memory unit 22 (step C110). When rotation start time [n, L1 is stored, rotation control time determination unit 12 sets identifier m of HDD 3 which is involved in a comparison to 1, and sets number K of a logical unit which is involved in the comparison to 0, to specify rotation start time [1, 0] which is to be compared. Rotation control time determination unit 12 also sets HDD count value i to 1 (step C111).

Then, rotation control time determination unit 12 compares m with n to check whether or not the HDD, which undergoes the start adjusting margin time setting process, is different from -the HDD which is involved in the comparison (step C112). When m is different from n, rotation control time determination unit 12 checks whether or not rotation start time [m, K] is stored in rotation control time memory unit 22 (step C113).

When rotation start time [m, K] is stored in rotation control time memory unit 22, rotation control time determination unit 12 checks whether or not the difference between rotation start time [n, L] and rotation start time [m, K] is smaller than the allowed time (step C114). The allowed time is a predefined time length which is set to a value larger than either the time required to activate the disk or the time required to stop the disk. The same allowed time may be set for all combinations of HDDs.

When the difference between rotation start time [n, L] and rotation start time [m, K] is smaller than the allowed time, rotation control time determination unit 12 adds one to count value i (step C115), and checks whether or not i is larger than the maximally allowed number (step C116). The maximally allowed number is set such that the consumed current does not exceed the value allowed for the device even if the maximally allowed number of HDDs 3 simultaneously start activating or stopping disks while all other HDDs 3 are rotating disks.

When i is larger than the maximally allowed number, rotation control time determination unit 12 subtracts the start adjusting margin time from rotation start time [n, L] stored in rotation control time memory unit 22 to calculate rotation start time [n, L] which is then recorded in rotation control time memory unit 22 (step C117), sets i=1, m=1, and K=0 (step C118), and returns to step C112 to perform the processing from step C112 onward. The start adjusting margin time is a margin for taking into consideration the time required to activate the disk, and is previously set longer than the time required to activate the disk.

When rotation start time [m, K] is not stored in rotation control time memory unit 22 at step C 113, or when the difference between rotation start time [n, L] and rotation start time [m, K] is equal to or larger than the allowed time at step C114, or when i is not larger than the maximally allowed number, rotation control time determination unit 12 checks whether or not K is equal to Lmax (step C119). When K is not equal to Lmax, rotation control time determination unit 12 adds one to K (step C120), and returns to step C112 to perform processing from step C112 onward.

When m is equal to n at step C112, or when K is equal to Lmax at step C119, rotation control time determination unit 12 checks whether or not m is equal to Max (step C121). When m is not equal to Max, rotation control time determination unit 12 adds one to m, sets K=0 (step C122), and returns to step C112 to perform processing from step C112 onward.

When rotation start time [n, L] is not stored in rotation control time memory unit 22 at step C110, or when m is equal to Max at step C121, rotation control time determination unit 12 checks whether or not L is equal to Lmax (step C123). When L is not equal to Lmax, rotation control time determination unit 12 adds one to L (step C124), and returns to step C 10 to perform processing from C110 onward.

When L is equal to Lmax at step C123, rotation control time determination unit 12 checks whether or not n is equal to Max (step C125). When n is not equal to Max, rotation control time determination unit 12 adds one to n, sets L=0 (step C126), and returns to step C110 to perform the processing from step C110 onward.

When n is equal to Max at step C125, rotation control time determination unit 12 proceeds to the fixed stop margin time setting process.

Next, the fixed stop margin time setting process will be described in connection with FIG. 14C. Referring to FIG. 14C, rotation control time determination unit 12 initially sets identifier n of HDD 3 which undergoes the fixed stop margin time setting process to 1, and sets number L of the logical unit which undergoes the fixed stop margin time setting process to 0, to specify rotation stop time [1, 0] for which a fixed stop margin time is set.

Next, rotation control time determination unit 12 checks whether or not use end time [n, L] is stored in use time memory unit 21 (step C128). When use end time [n, L] is stored, rotation control time determination unit 12 adds the fixed stop margin time to use end time [n, L] to calculate rotation stop time [n, L] which is then recorded in rotation control time memory unit 22 (step C129). The fixed stop margin time is a predefined time length which is set to a value larger than zero. The fixed stop margin time may be the same time for all HDDs 3.

Next, rotation control time determination unit 12 sets valid flag [n, L] in rotation control time memory unit 22 (step C130).

Next, rotation control time determination unit 12 checks whether or not L is equal to Lmax (step C131). When L is not equal to Lmax, rotation control time determination unit 12 adds one to L (step C132), and returns to step C128 to perform processing from step C128 onward.

When L is equal to Lmax at step C131, rotation control time determination unit 12 checks whether or not n is equal to Max (step C133). When n is not equal to Max, rotation control time determination unit 12 adds one to n (step C134), and returns to step C128 to perform processing from step C128 onward.

When use end time [n, L] is not stored in use time memory unit 21 at step C128, rotation control time determination unit 12 proceeds to step C131.

Rotation control time determination unit 12 repeats processing at steps C128-C134 to calculate rotation stop times for all corresponding logical units in all HDDs 3, whose use end times are stored in use time memory unit 21, and records the calculated rotation stop times in rotation control time memory unit 22.

When n is equal to Max at step C133, rotation control time determination unit 12 terminates the fixed stop margin time setting process, and proceeds to the stop adjusting margin time setting process.

Next, the stop adjusting margin time setting process will be described in connection with FIG. 14D. Referring to FIG. 14D, rotation control time determination unit 12 initially sets identifier n of HDD 3 which undergoes the stop adjusting margin time setting process to 1, and sets number L of a logical unit which undergoes the stop adjusting margin time setting process to 0 (step C135), to specify rotation stop time [1, 0] for which a stop adjusting margin time is set.

Next, rotation control time determination unit 12 checks whether or not rotation stop time [n, L] is stored in rotation control time memory unit 22 (step C136). When rotation stop time [n, L] is stored, rotation control time determination unit 12 sets identifier m of HDD 3 which is involved in a comparison to 1, and sets number K of a logical unit which is involved in the comparison to 0, to specify rotation start time [1, 0] and rotation stop time [1, 0] which undergo the comparison. Rotation control time determination unit 12 also sets HDD count value i to 1 (step C137).

Next, rotation control time determination unit 12 compares m with n to check whether or not HDD3, which undergoes the stop adjusting margin time setting process, is different from HDD 3 which is involved in the comparison (step C138). When m is different from n, rotation control time determination unit 12 checks whether or not rotation start time [m, K] is stored in rotation control time memory unit 22 (step C139). When rotation start time [m, K] is stored in rotation control time memory unit 22, rotation control time determination unit 12 checks whether or not the difference between rotation stop time [n, L] and rotation start time [m, K] is smaller than the allowed time (step C140). The allowed time used herein is the same as the tolerance used at step C114.

When the difference between rotation stop time [n, L] and rotation start time [m, K] is smaller than the allowed time, rotation control time determination unit 12 adds one to count value i (step C141), and checks whether or not i is larger than the maximally allowed number (step C142). The maximally allowed number used herein is the same as the maximally allowed number used at step C116.

When i is larger than the maximally allowed number, rotation control time determination unit 12 adds the stop adjusting margin time to rotation stop time [n, L] stored in rotation control time memory unit 22 to calculate rotation stop time [n, L] which is then recorded in rotation control time memory unit 22 (step C143), sets i=0, m=1, and K=0, and returns to step C138 to perform processing from step C138 onward. The stop adjusting margin time is a margin for taking into consideration time required to stop the disk, and is previously set longer than the time required to stop the disk.

When rotation start time [m, K] is not stored in rotation control time memory unit 22 at step C139, or when the difference between rotation stop time [n, L] and rotation start time [m, K] is equal to or larger than the allowed time at step C140, or when i is equal to or smaller than the maximally allowed number at step C142, rotation control time determination unit 12 checks whether or not rotation stop time [m, K] is stored in rotation control time memory unit 22 (step C145).

When rotation stop time [m, K] is stored in rotation control time memory unit 22, rotation control time determination unit 12 checks whether or not the difference between rotation stop time [n, L] and rotation stop time [m, K] is smaller than the allowed time (step C146). The allowed time at step C146 has the same value as the allowed time at step C140.

When the difference between rotation stop time [n, L] and rotation stop time [m, K] is smaller than the allowed time, rotation control time determination unit 12 adds one to count value i (step C147), and checks whether or not i is larger than a maximally allowed number (step C148). The maximally allowed number at step C148 is the same as the maximally allowed number at step C142.

When i is larger than the maximally allowed number, rotation control time determination unit 12 proceeds to step C143.

When rotation stop time [m, K] is not stored in rotation control time memory unit 22 at step C145, or when the difference between rotation stop time [n, L] and rotation stop time [m, K] is equal to or larger than the allowed time at step C146, or when i is equal to or smaller than the maximally allowed number at step C148, rotation control time determination unit 12 checks whether or not K is equal to Lmax (step C149). When K is not equal to Lmax, rotation control time determination unit 12 adds one to K (step C150), and returns to step C138 to perform processing from step C138 onward.

When m is equal to n at step C138, or when K is equal to Lmax at step C149, rotation control time determination unit 12 checks whether or not m is equal to Max (step C151).

When m is not equal to Max, rotation control time determination unit 12 adds one to m, sets K=0 (step C152), and returns to step C138 to perform the processing from step C138 onward.

When rotation stop time [n, L] is not stored in rotation control time memory unit 22 at step C136, or when m is equal to Max at step C151, rotation control time determination unit 12 checks whether or not L is equal to Lmax (step C153).

When L is not equal to Lmax, rotation control time determination unit 12 adds one to L (step C154), and returns to step C136 to perform processing from step C136 onward. When L is equal to Lmax at step C153, rotation control time determination unit 12 checks whether or not n is equal to Max (step C155). When n is not equal to Max, rotation control time determination unit 12 adds one to n, sets L=0 (step C156), and returns to step C136 to perform processing from step C136 onward. When n is equal to Max at step C155, rotation control time determination unit 12 terminates the rotation control time setting process.

The foregoing fixed start margin time setting process (FIG. 14A) and start adjusting margin time setting process (FIG. 14B) determine rotation start times for the corresponding logical units for all HDDs 3, whose use start times are stored in use time memory unit 21, and store the determined rotation start times in rotation control time memory unit 22, causing the valid flags to be set. Likewise, the foregoing stop fixed margin setting process (FIG. 14C0 and stop adjusting margin time setting process [FIG. 14D] determine rotation stop times for the corresponding logical units for all HDDs 3, whose use end times are stored in use time memory unit 21, and store the determined rotation stop times in rotation control time memory unit 22, causing the valid flags to be set.

Next, a description will be given of a specific example of operations performed by rotation control time determination unit 12 to determine the rotation start times and rotation stop times.

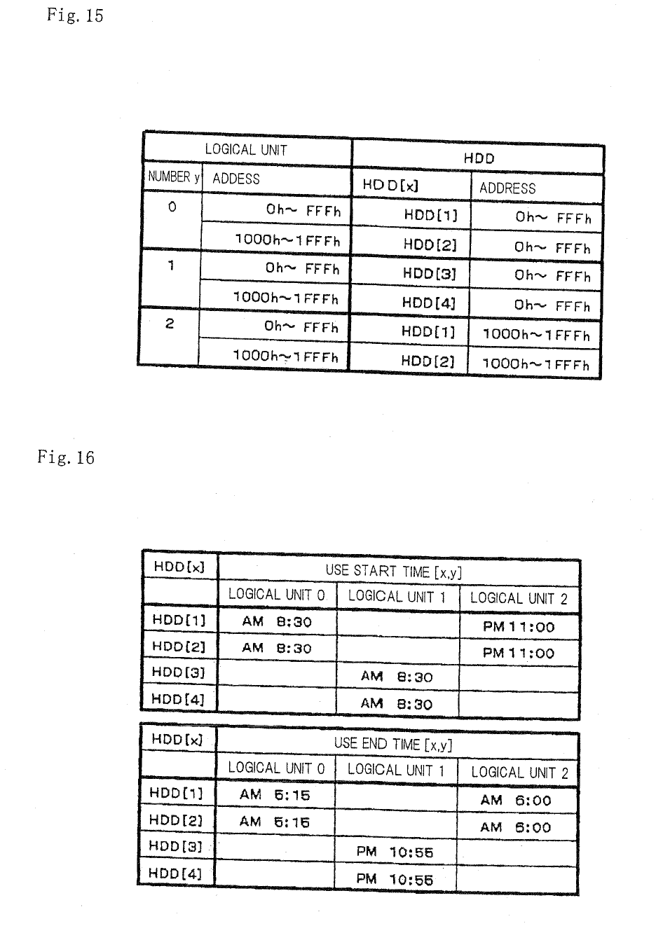

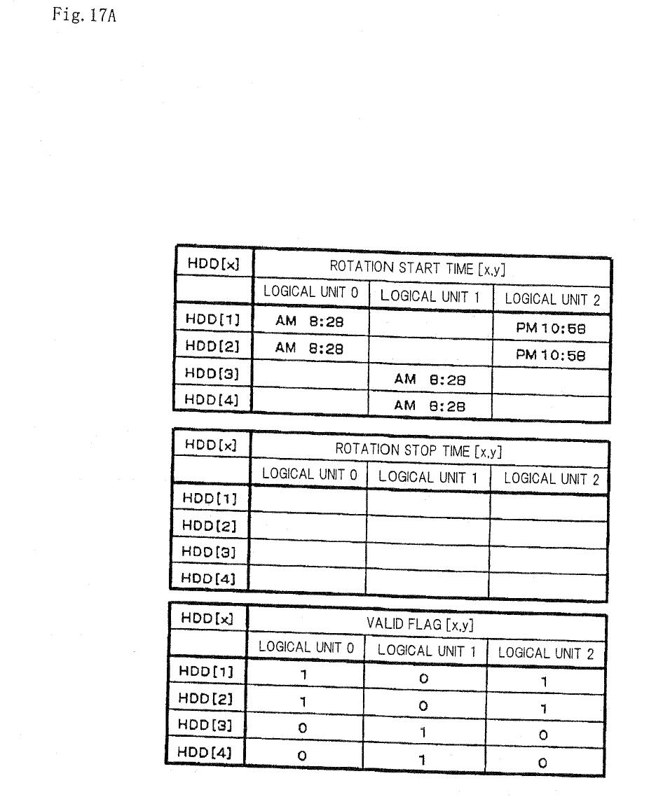

In this example, assume that the number of HDDs 3 is four, i.e., Max=4. Assume also that the fixed start margin time is set to two minutes; start adjusting margin time to two minutes; fixed stop margin time to three minutes; stop adjusting margin time to two minutes, allowed time to one minute; and maximally allowed number to two. Assume also that the number of logical units are three, i.e., Lmax=2. FIG. 15 is a table showing an example of logical unit information stored in logical unit information memory unit 23. FIG. 16 is a table showing an example of use start times and use end times stored in use time memory unit 21.

Assume herein that the logical unit information shown in FIG. 15 is set in logical unit information memory unit 23, where logical units correspond to the addresses of HDDs 3. In the settings of FIG. 15, logical unit 0 comprises HDD[1] and HDD[2], and logical unit 1 comprises HDD[3] and HDD[4]. Logical unit 2 comprises HDD[1] and HDD[2]. Also, assume herein that the use start times shown in FIG. 16 are stored in use time memory unit 21.

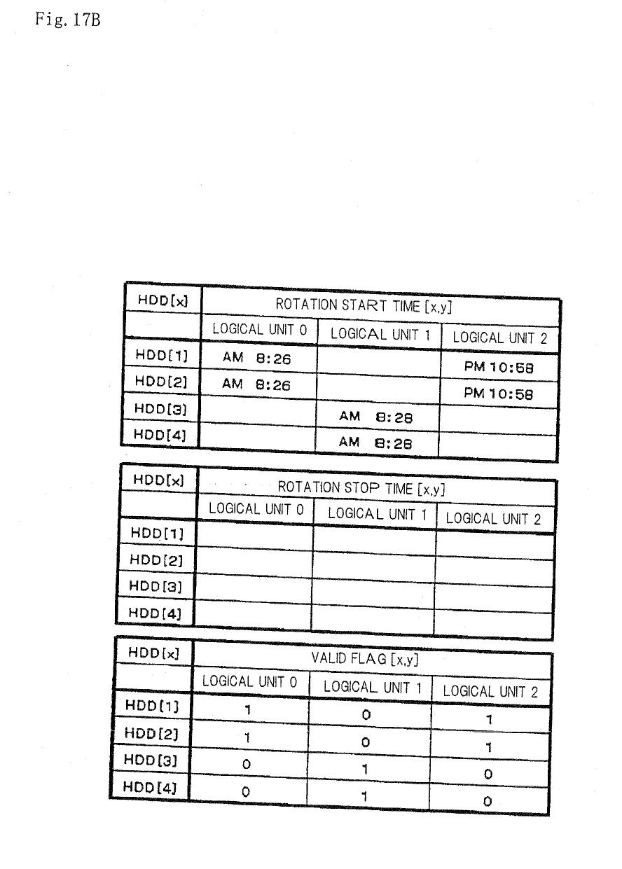

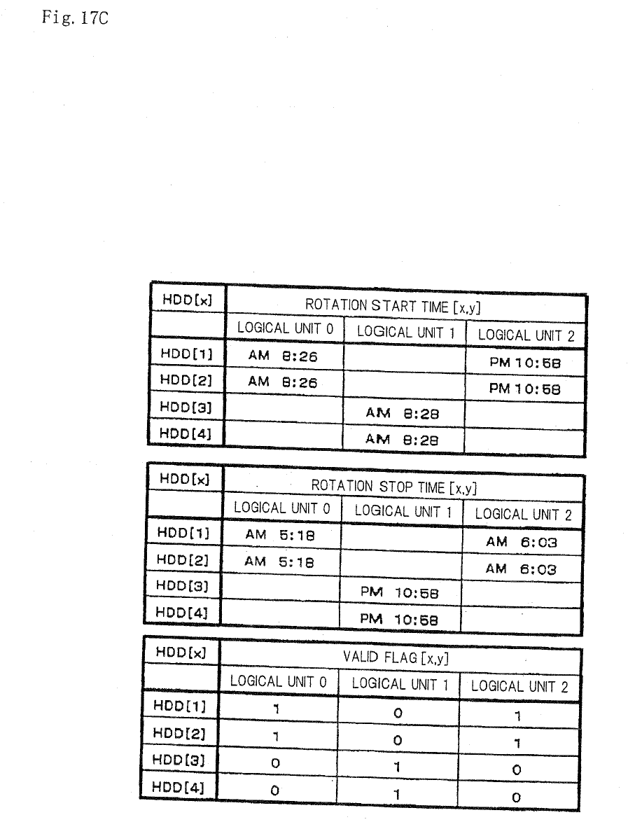

First, the fixed start margin time setting process (steps C101-C108) sets a time to be earlier by the amount of the fixed start margin time, i.e., two minutes earlier than the use start time to the rotation start time of each of the logical units corresponding to HDD[1] to HDD[4]. Also, the valid flags are set for those logical units to which the rotation start times are set. FIG. 17A is a table showing a first example of information set in rotation control time memory unit 22 in the second exemplary embodiment. Referring to FIG. 17A, the rotation start times are set to be earlier by two minutes than the use start times shown in FIG. 16. In FIG. 16, a set flag is represented by “1,” and a cleared flag is represented by “0.” FIGS. 17A-17D omit descriptions of the unit use flags and update flags in rotation control time memory unit 22.

Next, rotation control time determination unit 12 sets n to one, and L to zero (step C109), and executes processing at steps C110-C122, causing rotation start time [1, 0] to be earlier by the amount of the start adjusting margin time, i.e. two minutes.

Next, rotation control time determination unit 12 sets one to L (steps C123-C124), and executes step C110, but since rotation start time [1, 1] is not stored here, rotation control time determination unit 12 proceeds to L=2 (steps C123-C124).

For rotation start time [1, 2], as rotation control time determination unit 12 executes steps C110-C122 until m=4 is established, rotation start time [1, 2] remains at PM 10:58 without change. Subsequently, since L=Lmax at step C123, steps C110-C124 are repeated. In this way, rotation start time [2, 0] is determined to be at AM 8:26, and rotation start time [2, 2] at PM 10:58.

Further, as rotation control time determination unit 12 repeats steps C110-C126 for n=3 and n=4, the values of rotation start time [3, 1] and rotation start time [4, 1] remain at AM 8:28 without change. Since n becomes equal to Max at this time (step C124), rotation control time determination unit 12 terminates the rotation start time determination process. As a result, the values shown in FIG. 17B are stored in rotation control time memory unit 22.

Next, the fixed stop margin time setting process (steps C127-C134) sets times to be later by the amount of the fixed stop margin time, i.e., three minutes later than respective use start times (FIG. 16) to rotation stop times that correspond to respective logical units of HDD[1] to HDD[4]. FIG. 17C is a table showing a third example of rotation control times set in rotation control time memory unit 22 in the second exemplary embodiment. Referring to FIG. 17C, rotation control time memory unit 22 records rotation stop times, that are later by three minutes than the use start times shown in FIG. 16. Since all corresponding valid flags are set by the fixed start margin time setting process, the states of valid flags do not change here.

Next, rotation control time determination unit 12 executes the stop adjusting margin time setting process (steps C135-C156) to determine that all rotation stop times will have the same value as those before the stop adjusting margin time setting process, and to determine the rotation start times and rotation stop times will have the values in FIG. 17C.

By starting and stopping the rotation of HDDs 3 in accordance with the eventually determined rotation start times and rotation stop times in FIG. 17C, the number of HDDs 3 that exceed two, which is the maximally allowed number, are prevented from simultaneously being activated or stopped. It is possible to restrain concentration of activation and stop operations and to control rotating states of disks such that the consumed current does not exceed an allowed current value.

In this exemplary embodiment, the rotation start times are set to the number of logical units corresponding to single HDD 3. If a disk of HDD 3 has already been rotated in response to a rotation start instruction, the disk is kept rotating, so that a rotation start instruction to a certain logical unit will not affect access to other logical units.

Also, in this exemplary embodiment, the rotation stop times are set to the number of logical units corresponding to single HDD 3. If HDD 3 must be kept rotating for use by other logical units, no rotation stop instruction is issued, so that a rotation stop instruction to a certain logical unit will not affect access to other logical units.

While time is processed in minutes in the example shown above, the present invention is not so limited. In another exemplary embodiment, time may be processed in smaller units such as seconds.

As described above, the system according to this exemplary embodiment rotates disks of HDDs 3 including logical units that must be kept accessible, and stops disks of HDDs 3 not including logical units that must be kept accessible, based on the use start times and use stop times set for logical units arbitrarily set on storage areas provided by a plurality of HDDs 3. It is therefore possible to accomplish a reduction in power consumption and a fast response when accessed even if the user sets a use start time and a use end time to a logical unit without being aware of the configuration of HDDs 3. In addition, since the system according to this exemplary embodiment adjusts the rotation start time and rotation stop time of each HDD 3 to limit the number of HDDs 3 which simultaneously activate or stop, power consumption can be prevented from exceeding allowance of the device.

Also, since the system of this exemplary embodiment adjusts the rotation start time and rotation stop time of each HDD 3 based on a mutual relationship between the use start time and use end time of each logical unit, the user need not consider relationships between use start times and use end times of other logical units and between HDDs 3 and logical units when he enters a use start time and a use end time.

### Third Embodiment

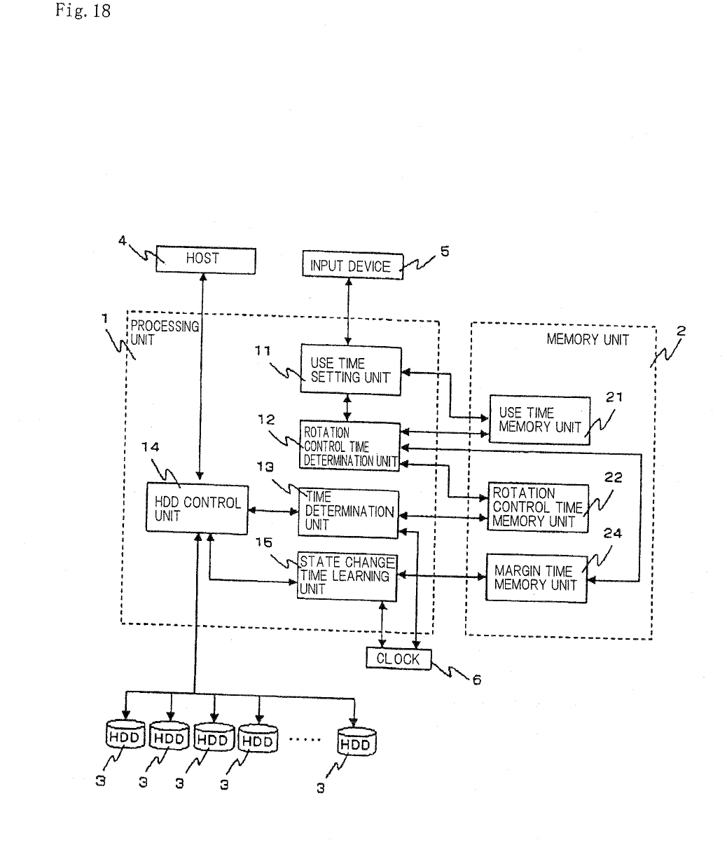

FIG. 18 is a block diagram illustrating a system according to a third exemplary embodiment. In the system of the third exemplary embodiment illustrated in FIG. 18, processor 1 comprises state change time learning unit 15, and memory unit 2 comprises margin time memory unit 24, in addition to the components of the first exemplary embodiment illustrated in FIG. 1.

State change time learning unit 15 receives an instruction notification from HDD control unit 14, when HDD control unit 14 issues a rotation start instruction to HDD 3, acquires the time from clock 6, and records the acquired time in margin time memory unit 24 as an instruction time. The time acquired from clock 6 is the current time at that time.

Also, when HDD control unit 14 receives a response to the rotation start instruction from HDD 3, state change time learning unit 15 receives a response notification from HDD control unit 14, acquires the time from clock 6, and records the acquired time in margin time memory unit 24 as a response time.

State change time learning unit 15 also calculates an activation time, a fixed start margin time, and a start adjusting margin time from the instruction time and response time, and records them in start margin time memory unit 24.

Margin time memory unit 24 stores the instruction time, response time, activation time, fixed start margin time, and start adjusting margin time for respective HDDs 3.

Upon issuing a rotation start time to HDD 3, HDD control unit 14 transmits an instruction notification to state change time learning unit 15 to that effect. Also, upon receipt of a response to the rotation start instruction from HDD 3, HDD control unit 14 transmits a response notification to state change time learning unit 15 to that effect.

HDD 3 of this exemplary embodiment starts rotating the disk in response to a rotation start instruction from HDD control unit 14, and returns a response to HDD control unit 14 when it becomes accessible.

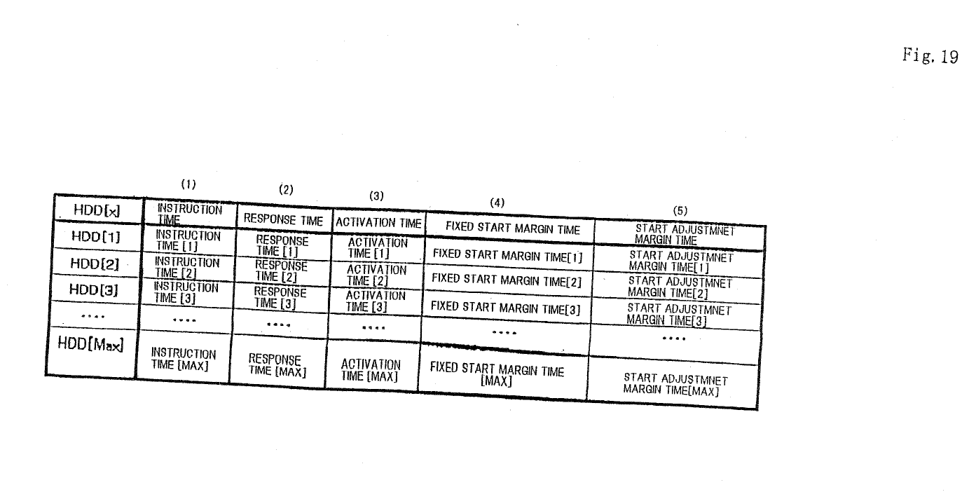

In the following description, individual HDD3 is labeled HDD[x], where reference numeral x is used to identify one of a plurality of HDDs 3. The total number of HDDs 3 is represented by Max. Specifically, individual HDDs 3 are labeled HDD[1] to HDD[Max]. Also, an instruction time of HDD[x] is represented by instruction time [x]; a response time of HDD[x] by response time [x]; an activation time of HDD[x] by activation time [x]; a fixed start margin time of HDD[x] by fixed start margin time [x]; and a start adjusting margin time of HDD[x] by fixed start margin time [x]. FIG. 19 is a table showing information stored in margin time memory unit 24 in the third exemplary embodiment. Using the labels mentioned above, the information stored in margin time memory unit 24 are as shown in FIG. 19.

The system of the third exemplary embodiment is similar in configuration to the first exemplary embodiment except for the components described above.

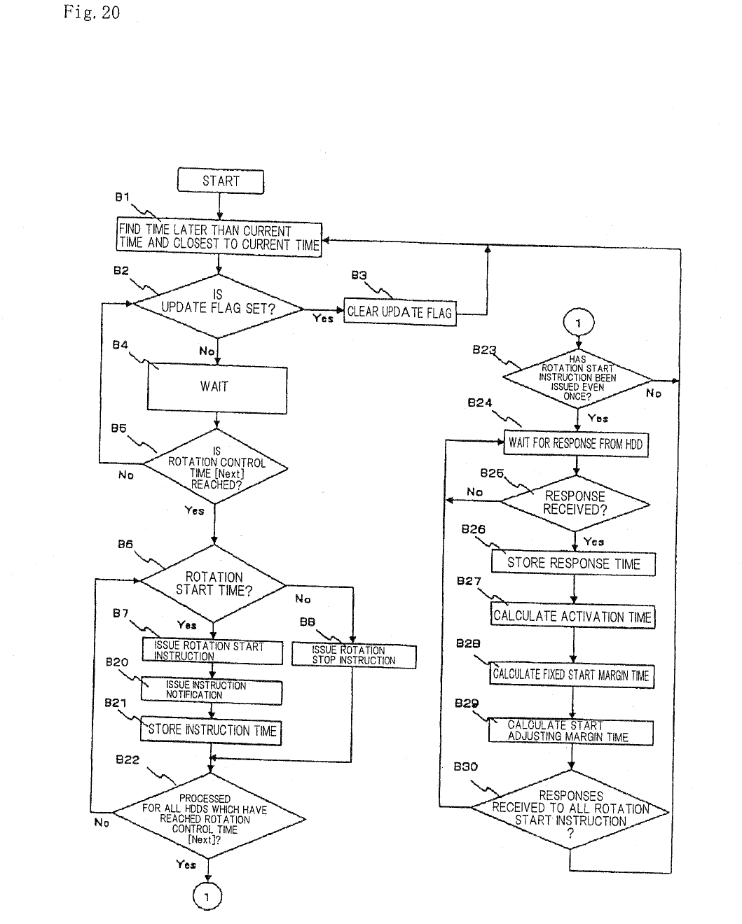

Next, a description will be given of the overall operation of the system of this exemplary embodiment, mainly in regard to differences with the first exemplary embodiment. FIG. 20 is a flow chart illustrating a rotation control time determination process in the third exemplary embodiment.

Referring to the flow chart of FIG. 20, this flow chart differs from the flow chart of the HDD control process in the first exemplary embodiment illustrated in FIG. 5 in the processing from step B6 onward. At step B6, when rotation control time [Next] is equal to the rotation start time, time determination unit 13 issues a rotation start instruction to a relevant HDD through HDD control unit 14 (step B7). Upon receipt of the rotation start instruction, HDD control unit 14 sends an instruction notification to state change time learning unit 15 (step B20). The instruction notification sent by HDD control unit 14 to state change time learning unit 15 includes information that indicates to which HDD the rotation start instruction is issued.

Upon receipt of the instruction notification, state change time learning unit 15 acquires the time from clock 6, and stores the time in an instruction time area for the relevant HDD in margin time memory unit 24 (step B21).

When rotation control time [Next] is equal to rotation stop time at step B6, time determination unit 13 issues a rotation stop instruction to the relevant HDD through HDD control unit 14 (step B8).

If there are a plurality of HDDs 3 that correspond to the rotation control time [Next], time determination unit 13 returns to step B6 to repeat processing at steps B7, B20, B21 and B8 for all relevant HDDs 3 (step B22).

After issuing the rotation start instructions or rotation stop instructions to all rotation control times [Next], time determination unit 13 waits for a response from HDD 3 (step B24) even if only one rotation start instruction has been issued (step B23). Then, upon receipt of a response from HDD 3 (step B25), HDD control unit 14 sends a response notification to state change time learning unit 15. The response notification sent by HDD control unit 14 to state change time learning unit 15 includes information that indicates from which HDD the response was sent. Upon receipt of the response notification, state change time learning unit 15 acquires the time from clock 6, and stores the acquired time in a response time area for relevant HDD in margin time memory unit 24 (step B26).

Next, state change time learning unit 15 subtracts the instruction time from the response time, both stored in margin time memory unit 24, to calculate an activation time which is then stored in an activation time area for relevant HDD in margin time memory unit 24 (step B27).

Next, state change learning unit 15 adds a fixed start margin correction time to the activation time stored in margin time memory unit 24 to calculate a fixed start margin time which is then stored in a fixed start margin time area for the relevant HDD 3 in margin time memory unit 24 (step B28). The fixed start margin correction time is a previously set time, and may be the same time for all HDDs 3.

Next, state change time learning unit 15 adds a start adjusting margin correction time to the activation time stored in margin time memory unit 24 to calculate a start adjusting margin time which is then stored in the start adjusting margin time area for the relevant HDD 3 in margin time memory unit 24 (step B29). The start adjusting margin correction time is a previously set time, and may be the same time for all HDDs 3.

Next, when responses have been made to all the issued rotation start instructions (step B30), the flow goes to step B1. When no response is received at step B25, or when rotation start instructions remain to which responses have not yet been received at step B30, the flow goes to step B24.

The HDD control process illustrated in FIG. 20 sets the fixed start margin time and start adjusting margin time based on actual measurements for HDDs 3 even if rotation start instruction have only been issued to HDDs once.

The flow chart of the rotation control time determination process in this exemplary embodiment is the same as that illustrated in FIG. 4 in the first exemplary embodiment.

Also, the flow chart of the rotation control time setting process executed by rotation control time determination unit 12 to determine the rotation start times and rotation stop times is the same as those illustrated in FIGS. 6A-6D in the first exemplary embodiment.

However, values stored in start margin time memory unit 24 for each HDD 3 are employed for the fixed start margin time used at step C3 in FIG. 6A and for the start adjusting margin time used at step C14 in FIG. 6B.

If the fixed start margin time or start adjusting margin time is not stored in margin time memory unit 24, a previously set value is used. Previously set fixed start margin time and start adjusting margin time may be values larger than the maximum time required to activate the disk of each HDD 3.

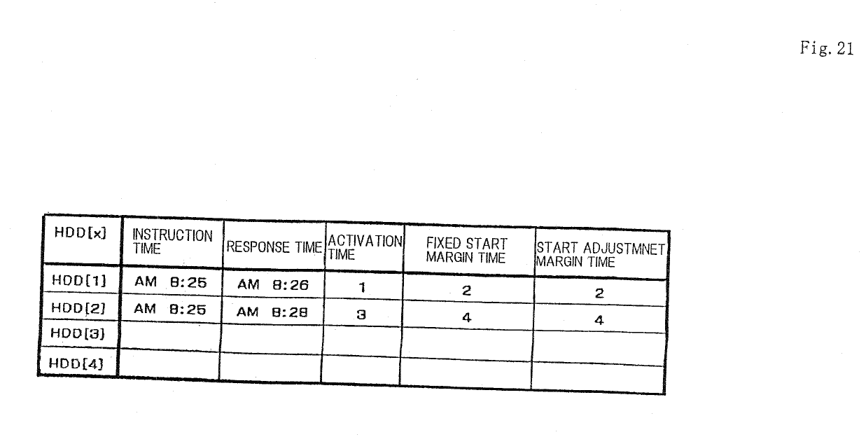

FIG. 21 is a table showing a specific example of information stored in margin time memory unit 24 in the third exemplary embodiment. In this example, assume that the number of HDDs is four, i.e., Max=4. Also, the fixed start margin correction time is set to one minute, and the start adjusting margin correction time to one minute.

FIG. 21 shows an example of stored information after a rotation start instruction has been issued once or more to each of HDD[1] and HDD[2], and after steps B5-B30 in FIG. 20 have been executed.

In this example, either HDD[1] or HDD[2] shows the same -instruction time at AM 8:25, but they differ in response time, i.e., HDD[1] presents a response time at AM 8:26, while HDD[2] presents a response time at 8:28. This means that HDD[1] requires an activation time of one minute, while HDD[2] requires an activation time of three minutes, in other words, HDD[2] requires a longer time for activating the disk than HDD[1]. The rotation control time determination process illustrated in FIG. 20 sets the fixed start margin time and start adjusting margin time for HDD[2] to be longer by two minutes than the fixed start margin time and start adjusting margin time for HDD[1], respectively.

While this exemplary embodiment has shown an example in which the fixed start margin time and start adjusting margin time are learned based on actual measurements, the fixed stop margin time and stop adjusting margin time can also be learned by a similar method. In this event, as HDD control unit 14 receives a response to a rotation stop instruction, state change time learning unit 15 can calculate the time required to stop the rotation (stop time), and add correction values (stop fixed margin correction time and stop adjustment margin correction time) to the calculated time, thus calculating the fixed stop margin time and stop adjusting margin time.

Also, while time is processed in minutes in the example shown above, the present invention is not so limited. In another exemplary embodiment, time may be processed in smaller units such as seconds.

As described above, according to this exemplary embodiment, state change time learning unit 15 measures the activation time (stop time) of each HDD 3 to calculate the margin times for each HDD 3, and rotation control time determination unit 12 determines a rotation control time using the margin times, so that the disk state of each HDD 3 can be controlled at an appropriate time even if HDDs 3 differ in disk activation time from one another. As a result, it is possible to accomplish both a reduction in power consumption and a fast response when accessed, and prevent the power consumption from exceeding the allowance of the device due to simultaneous activations of HDDs 3.

While preferred embodiments of the present invention have been described using specific terms, such description is for illustrative purposes only, and it is to be understood that changes and variations may be made without departing from the spirit or scope of the following claims.

What is claimed is:

1. A disk array control apparatus for individually controlling disk states of a plurality of hard disk drives disposed in a disk array, comprising:
a rotation control time determination unit for calculating a control time for controlling the disk state of each of said plurality of hard disk drives based on previously set time information related to a start and a stop of use, and adjusting the calculated control times based on a mutual relationship of the control times to one another; and
a hard disk drive control unit for controlling the disk state of each hard disk drive at the control time determined by said rotation control time determination unit.

2. The disk array control apparatus according to claim 1, wherein:
said plurality of hard disk drives include arbitrary logical units on storage areas provided thereby,
said previously set time information includes a use time which is set to correspond to each logical unit, and
said rotation control time determination unit determines the control time for each of said hard disk drives based on the correspondence relationship between said hard disk drives and said logical units, the use times set for said logical units, and a mutual relationship between the use times.

3. The disk array control apparatus according to claim 1, wherein:
said use time includes a use start time and a use end time, and
said rotation control time determination unit determines the control time for each of said hard disk drives so as to bring a corresponding hard disk drive into a rotating state from the set use start time to the use end time, and to limit the number of hard disk drives whose disk states are simultaneously changed.

4. The disk array control apparatus according to claim 1, further comprising:
a state change time learning unit for measuring a state change time required from a start to an end of a change in the disk state of said hard disk drive under the control of said hard disk drive control unit,
wherein said rotation control time determination unit uses the state change time measured by said state change time learning unit when said rotation control time determination unit determines the control time for each of said hard disk drives.

5. A disk array control method for individually controlling disk states of a plurality of hard disk drives disposed in a disk array, comprising:
calculating a control time for controlling the disk state of each of said plurality of hard disk drives based on previously set time information related to a start and a stop of use, and adjusting the calculated control times based on a mutual relationship of the control times to one another; and
controlling the disk state of each hard disk drive at the determined control time.

6. The disk array control method according to claim 5, wherein:
said plurality of hard disk drives include arbitrary logical units on storage areas provided thereby, and said previously set time information includes a use time which is set to correspond to each logical unit, and
said control time is determined for each of said hard disk drives based on the correspondence relationship between said hard disk drives and said logical units, the use times set for said logical units, and a mutual relationship between the use times.

7. The disk array control method according to claim 5, comprising:
setting a use start time and a use end time as the use time; and
determining said control time for each of said hard disk drives so as to bring a corresponding hard disk drive into a rotating state from the set use start time to the use end time, and to limit the number of hard disk drives whose disk states are simultaneously changed.

8. The disk array control method according to claim 5, further comprising:
measuring a state change time required from a start to an end of a change in disk state of said hard disk drive,
wherein said measured state change time is used when the control time is determined for each of said hard disk drives.

9. A recording medium which stores a program for causing a computer to operate as a disk array control apparatus for individually controlling disk states of a plurality of hard disk drives disposed in a disk array, said program comprising:
a procedure for calculating a control time for controlling the disk state of each of said plurality of hard disk drives based on previously set time information related to a start and a stop of use, and adjusting the calculated control times based on a mutual relationship of the control times to one another; and
a procedure for controlling the disk state of each hard disk drive at the control time.

10. The recording medium which stores a program according to claim 9, wherein:
said plurality of hard disk drives include arbitrary logical units on storage areas provided thereby, and said previously set time information includes a use time which is set to correspond to each logical unit, and
said control time is determined for each of said hard disk drives based on the correspondence relation between said hard disk drives and said logical units, the use times set for said logical units, and a mutual relationship between the use times.

11. The recording medium which stores a program according to claim 9, wherein:
a use start time and a use end time are set as the use time, and
said control time is determined for each of said hard disk drives so as to bring a corresponding hard disk drive into a rotating state from the set use start time to the use end time, and to limit the number of hard disk drives whose disk states are simultaneously changed.

12. The recording medium which stores a program according to claim 9, further comprising:
a procedure for measuring a state change time required from a start to an end of a change in the disk state of said hard disk drive,
wherein said measured state change time is used when the control time is determined for each of said hard disk drives.

13. A disk array control apparatus for individually controlling disk states of a plurality of hard disk drives disposed in a disk array, comprising:
rotation control time determining means for calculating a control time for controlling the disk state-of each of said plurality of hard disk drives based on previously set time information related to a start and a stop of use, and adjusting the calculated control times based on a mutual relationship of the control times to one another; and
hard disk drive control means for controlling the disk state of each hard disk drive at the control time determined by said rotation control time determining means.
